(19) United States
(12) Patent Application Publication
(10) Pub. No.: US 2010/0265250 A1
(43) Pub. Date: Oct. 21, 2010

(54) METHOD AND SYSTEM FOR FAST RENDERING OF A THREE DIMENSIONAL SCENE

(76) Inventors: David Koenig, Los Angeles, CA (US); Yoni Koenig, Los Angeles, CA (US); Robert Knaack, Los Angeles, CA (US); Brian Anderson, Berlin (DE)

Correspondence Address: PERKINS COIE LLP, P.O. BOX 1208, SEATTLE, WA, 98111-1208, US

(21) Appl. No.: 12/523,526

(22) PCT Filed: Aug. 25, 2008
(86) PCT No.: PCT/US2008/010056

§ 371 Date: Feb. 26, 2010

Related U.S. Application Data
(60) Provisional application No. 61/016,136, filed on Dec. 21, 2007.
(60) Provisional application No. 61/085,386, filed on Jul. 31, 2008.

(51) Int. Cl. G06T 15/00

(52) U.S. Cl. 345/419

(57) ABSTRACT

A method and system for computing a fast render of a three-dimensional scene. Software objects including object properties represent three-dimensional models within an animation sequence. Object properties store discrete values at a point in time within the animation sequence. A specified frame within the animation sequence is calculated on demand from object properties without calculating preceding frames. A graphical user interface can be dynamically generated from object properties for interfacing between the users and the object properties.

### CROSS REFERENCE TO RELATED APPLICATIONS

This application claims priority to U.S. Provisional Patent Application No. 61/016,136 entitled “Dynamic Graphical User Interface Generation in a Three-Dimensional Computer Graphics System”, filed 21 Dec. 2007 and U.S. Provisional Patent Application No. 61/085,386 entitled “Method and System for Object Atomization”, filed 31 Jul. 2008, which are incorporated by reference.

### BACKGROUND

Three-dimensional computer graphics utilize a stored three-dimensional representation of geometric data. Calculations are performed on the data and two-dimensional images are rendered for later display or for real-time viewing. The geometric data is often stored in a graphical data file, mathematically representing the three-dimensional object. The object is displayed visually as a two-dimensional image through a process called rendering.

Before rendering occurs, one or more objects can be placed within a virtual scene. The placement and properties of the objects defines spatial relationships between the objects including location and size. Animation can define a temporal description of an object, for example, how the object moves and deforms over time. Popular animation methods include keyframing, inverse kinematics, and motion capture. Motion can also be specified through physical simulation.

Rendering creates the actual two-dimensional image or animation for display from the scene. Several different, and often specialized, rendering methods can be used. Methods range from the distinctly non-realistic wireframe rendering through polygon-based rendering, to more advanced techniques such as scanline rendering, ray tracing, or radiosity. Rendering can take from seconds to days for a single image/frame and is generally computationally expensive.

Techniques have been developed for the purpose of simulating other naturally-occurring effects, such as the interaction of light with various forms of matter. Examples of such techniques include particle systems (which can simulate rain, smoke, or fire), volumetric sampling (to simulate fog, dust and other spatial atmospheric effects), caustics (to simulate light focusing by uneven light-refracting surfaces, such as the light ripples seen on the bottom of a swimming pool), ray-tracing (to generate an image by tracing the path of light through pixels in an image plane) and subsurface scattering (to simulate light reflecting inside the volumes of solid objects such as human skin).

Animations for non-interactive media, such as feature films and video, include frames that are displayed sequentially. Such frames are rendered more slowly at high quality. Rendering times for individual frames can vary from a few seconds to several days for complex scenes. Rendered frames are stored in memory and can be transferred to other media such as motion picture film or optical disk. These frames are then displayed sequentially at high frame rates, typically 24, 25, or 30 frames per second, to achieve the illusion of movement.

Previous three-dimensional visualization software utilized a time-consuming and limited process with clearly delineated steps to modify a scene and generate a sequence. A camera position is first established. Character performance is then described. Texture placements are made. Material adjustments are made. Lighting setup is defined. After each step, the user instructs a computer system to render the scene before reviewing the results and possibly making changes. If changes are made, the scene must be rendered again for review. Combined with the long render times provided by previous software, this process was cumbersome, unintuitive, and did not encourage user creativity.

Previous approaches to improve performance included outsourcing some rendering duties, such as lighting passes and material shaders, to a graphics processing unit. Example programs using this approach include Gelato and Click-VR for three-dimensional StudioMax users. However, these programs still require the user define each change in the scene before rendering the scene for review.

Previous approaches provide a user interface which receives object values for a scene from a user. Responsive to a user command to render the scene, the values are provided to a processing unit for rendering. The processing unit executes the necessary calculations and outputs a render. For example, the processing unit can be a central processing unit (CPU). Unfortunately, this procedure is cumbersome and slow, forcing a user into an iterative process of creating a scene.

Furthermore, previous approaches in rendering frames of an animation sequence define a starting state for each object within the scene. Each frame is then rendered, in part, based on a preceding frame. This makes random access display of a mid-sequence frame (for example, during editing) time-consuming, as each preceding frame must be first rendered.

### BRIEF DESCRIPTION OF THE DRAWINGS

FIG. 1 illustrates an example system for providing fast calculation of a selected frame within an animation sequence.

FIG. 2 illustrates an example data structure for providing fast calculation of a selected frame within an animation sequence.

FIG. 3 illustrates an example procedure for providing fast calculation of a selected frame within an animation sequence.

FIG. 4 illustrates an example procedure for providing near real-time renders responsive to user-inputted values.

FIG. 5 illustrates an example procedure for providing a three-dimensional visualization software.

FIG. 6A illustrates an example screen shot from a three-dimensional visualization software.

FIG. 6B illustrates another example screen shot from a three-dimensional visualization software.

FIG. 6C illustrates another example screen shot from a three-dimensional visualization software.

FIG. 6D illustrates another example screen shot from a three-dimensional visualization software.

FIG. 6E illustrates another example screen shot from a three-dimensional visualization software.

FIG. 6F illustrates another example screen shot from a three-dimensional visualization software.

FIG. 6G illustrates another example screen shot from a three-dimensional visualization software.

FIG. 6H illustrates another example screen shot from a three-dimensional visualization software.

FIG. 6I illustrates another example screen shot from a three-dimensional visualization software.

FIG. 6J illustrates another example screen shot from a three-dimensional visualization software.

FIG. 6K illustrates another example screen shot from a three-dimensional visualization software.

FIG. 6L illustrates another example screen shot from a three-dimensional visualization software.

FIG. 6M illustrates another example screen shot from a three-dimensional visualization software.

FIG. 6N illustrates another example screen shot from a three-dimensional visualization software.

FIG. 7A illustrates an example screen shot of an attachment node interface in a three-dimensional visualization software.

FIG. 7B illustrates an example screen shot of a channel editor interface in a three-dimensional visualization software.

FIG. 7C illustrates an example screen shot of fur GUI in a three-dimensional visualization software.

FIG. 7D illustrates an example screen shot of a glow shader interface in a three-dimensional visualization software.

FIG. 7E illustrates an example screen shot of hot key definition interface in a three-dimensional visualization software.

FIG. 7F illustrates an example screen shot of a layers interface in a three-dimensional visualization software.

FIG. 7G illustrates an example screen shot of a light set object interface in a three-dimensional visualization software.

FIG. 7H illustrates an example screen shot of a phong shader interface in a three-dimensional visualization software.

FIG. 7I illustrates an example screen shot of a point light system interface in a three-dimensional visualization software.

FIG. 7J illustrates an example screen shot of a projected light system interface in a three-dimensional visualization software.

FIG. 7K illustrates an example screen shot of a reflection shader interface in a three-dimensional visualization software.

FIG. 7L illustrates an example screen shot of a render preferences interface in a three-dimensional visualization software.

FIG. 7M illustrates an example screen shot of a specular shift hair shader interface in a three-dimensional visualization software.

FIG. 7N illustrates an example screen shot of a sub surface scatter shader interface in a three-dimensional visualization software.

FIG. 7O illustrates an example screen shot of a surface AO system interface in a three-dimensional visualization software.

FIG. 7P illustrates an example screen shot of a water shader interface in a three-dimensional visualization software.

### DETAILED DESCRIPTION

A three-dimensional scene is rendered in substantially real-time, responsive to individual user-inputted values modifying object values within the scene. The scene is rendered immediately after a graphical user interface receives the object values, without waiting for a specific user “render” command. The user interface provides new and modified object values directly to processing units and computational hardware that compute the render. Thus, changes in object values are immediately reflected in an output render, allowing for near real-time feedback to the user when creating or revising a scene.

There is a need for automatic near real-time visualization responsive to user changes of a scene in three-dimensional visualization software. A method and system provide a dynamically generated graphical user interface (GUI) integrated with a graphics processing unit (GPU) for use within the three-dimensional visualization software. The GPU automatically generates visualizations responsive to user-inputted changes to objects in a scene. This provides near real-time feedback to user changes and modifications within the scene.

Furthermore, the system provides fast render through calculation of a selected frame associated with a point in time within an animation sequence. Three-dimensional models within the animation sequence are represented by software objects on a computer graphics system. The software objects eliminate the need for the system to calculate preceding frames before calculating the selected frame.

Object properties, for example, representing the object's position, color, shading, lighting, etc., are stored in “channels.” A “driver” stores values associated with the channel, as the values change over time during the animation sequence. A “key” stores a single value or set of values associated with the channel at a single point in time of the animation sequence.

The specified frame is calculated on demand from information stored in the drivers and keys. Object properties stored in drivers are immediately accessed for inclusion into the specified frame. Object properties stored in keys are blended to calculate a property value at the point in time of the specified frame. Once the properties of the specified frame are calculated, the frame is complete and can be displayed.

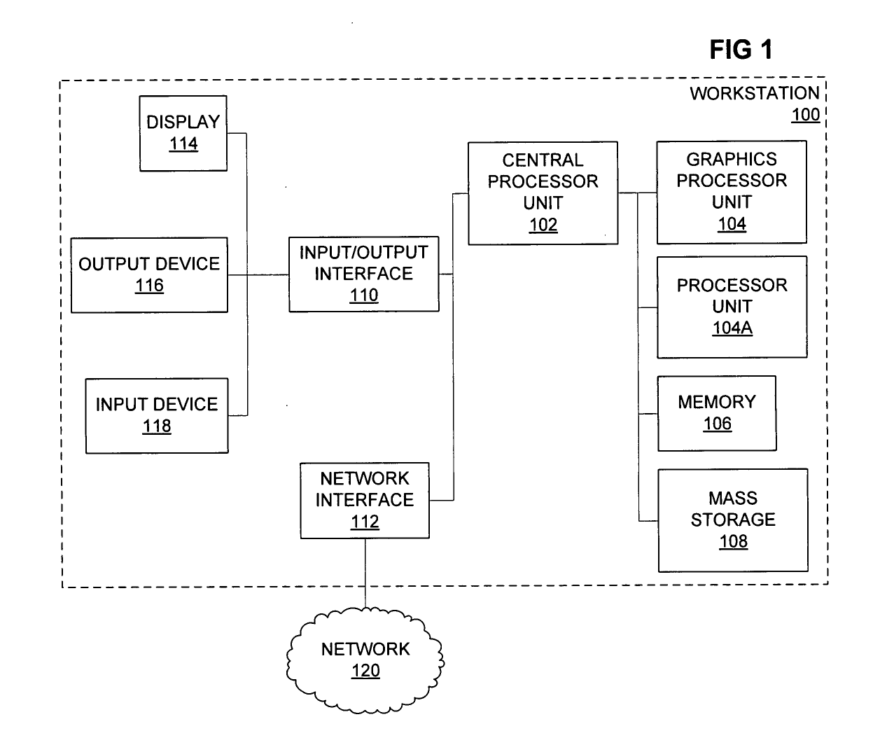

FIG. 1 illustrates an example system for providing fast calculation of a selected frame within an animation sequence. The system can include a workstation 100 that includes a central processor unit (CPU) 102, a graphics processor unit (GPU) 104, a processor unit 104A, a memory 106, a mass storage 108, an input/output interface 110, a network interface 112, a display 114, an output device 116, and an input device 118. The work station can communicate with a network 120.

In the example of FIG. 1, the workstation 100 can be a computing device such as a personal computer, desk top, laptop, or other computer. The workstation can be accessible to a user and provide a computing platform for a three-dimensional visualization software. The workstation can be configured to provide high performance with respect to graphics, processing power, memory capacity, and multitasking ability. Alternatively, any computing device can be used, such as a mobile computer, a personal digital assistant (PDA), a distributed system, or any other device.

For example, the computing device can be a render farm. A render farm is a computer cluster to render computer graphics in off-line batch processing. Because image rendering can be parallelized, a large number of computing devices can be used to improve render speed.

In the example of FIG. 1, the CPU 102 can be an integrated circuit configured for mass-production and suited for a variety of computing applications. The CPU can sit on a motherboard within the workstation and control other workstation components. The CPU can communicate with the other workstation components via a bus, a physical interchange, or other communication channel.

In the example of FIG. 1, the GPU 104 can be a dedicated graphics rendering device for a personal computer, workstation, game console, and mobile device such as PDA, cellular phone, ultra-mobile PC, or any other computing device. For example, the GPU can be a special purpose integrated circuit processor similar to the CPU. The GPU can be designed for efficient manipulating and displaying of computer graphics. The GPU can have a highly parallel structure more suitable for complex algorithms than general-purpose CPUs. For example, a GPU can be included with a video card or be integrated directly into the motherboard.

In the example of FIG. 1, the processor unit 104A can be a general purpose processor or a special purpose processor configured to execute computations related to graphical applications. The processor unit 104A can be similar to the GPU 104.

Alternatively, General-Purpose Graphics processing units (GPGPUs can also be used, where the GPGPU is configured as a GPU to perform computations in non-graphical applications. For example, the GPGPU may be similar to a GPU but with the addition of programmable stages and higher precision arithmetic to the rendering pipelines. This allows software developers to use stream processing on non-graphics data.

While only one CPU 102, one GPU 104 and one processor unit 104A are depicted, it will be appreciated that any number of CPUs, GPUs, processor units or any other computing devices can be included in the workstation 100. Additional units add computational resources to the workstation 100. It will be appreciated that any computing device that can be configured to execute render-related computations or calculations can be used as the CPU 102 and GPU 104.

In the example of FIG. 1, additional hardware can be included in the workstation 100 to help render a scene. For example, additional memory or processing units can be added to improve performance capabilities.

In one example, user-inputted values are immediately transmitted to the GPU 104 and/or the processor unit 104A for computing a render of the scene. In another example, the GPU 104 and the processor unit 104A can have registers that are directly accessible by the CPU 102. When values are written into the registers, the GPU 104 and the processor unit 104A are immediately used in calculating a render.

In the example of FIG. 1, the memory 106 can include volatile and non-volatile memory accessible to the CPU and GPU. The memory can be random access and provide fast access for graphics-related or other calculations. In an alternative, both the CPU and the GPU can also include on-board cache memory for faster performance.

In the example of FIG. 1, the mass storage 108 can be volatile or non-volatile storage configured to store large amounts of memory, such as a graphics file. The mass storage can be accessible to the CPU and the GPU. For example, the mass storage can be a hard drive, a RAID array, flash memory, CD-ROMs, DVDs, HD-DVD or Blu-Ray mediums.

In the example of FIG. 1, the input/output interface 110 can include logic and physical ports used to connect and control peripheral devices, such as input and output devices. For example, the input/output interface can allow input and output devices to be connected to the workstation and interface between the devices and the workstation.

In the example of FIG. 1, the network interface 112 can include logic and physical ports used to connect to one or more networks. For example, the network interface can accept a physical network connection and interface between the network and the workstation by translating communications between the two. Example networks can include Ethernet, or other physical network infrastructure.

In the example of FIG. 1, the display 114 can be is electrical equipment which displays viewable images generated by the workstation to the user. For example, the display can be a cathode ray tube or some form of flat panel such as a TFT LCD. The display includes the display device, circuitry to generate a picture from electronic signals sent by the computer, and an enclosure or case. The display can interface with the input/output interface which converts data to a format compatible with the display.

In the example of FIG. 1, the output device 116 can be any hardware used to communicate computation results to the user. For example, the output device can include speakers and printers, in addition to the display discussed above.

In the example of FIG. 1, the input device 118 can be any computer hardware used to translate inputs received from the user into data usable by the workstation. The input device can include keyboards, mouse pointer devices, microphones, scanners, video and digital cameras, etc.

In the example of FIG. 1, the network 120 can be any network configured to carry digital information. For example, the network can be an Ethernet network, the Internet, or any Local Area Network or Wide Area Network.

In an alternative, the work station can be a client device in communications with a server over the network. In this example, the client device can be equipped with lower performance (and thus have a lower hardware cost) and the server provides necessary processing power necessary.

In the example of FIG. 1, in operation, a user interacts with a user interface provided on the output device 116 and input device 118. The user inputs values for objects within a scene. The object values are received by the central processor unit 102 and directly written into appropriate registers of the GPUS 104 and the processor unit 104A. The GPU 104 and processor unit 104A immediately compute a render based on the object values, and the render is displayed to the user on output device 116.

By eliminating storing the object values in memory 106 and by directly accessing registers, the workstation 100 can provide a substantially real time render responsive to user inputted object values.

In the example of FIG. 1, in operation, objects representing a three-dimensional model are stored in memory 106. Object properties can be stored in “keys” or “drivers”, which are used when a specified frame is to be calculated, as discussed below. The workstation 100 interacts with the user through output device 116 and input device 118.

In the example of FIG. 1, in operation, the user enters new or revised values for various keys and drivers via a graphical user interface supplied by the output device 116 and the input device 118. The values are immediately processed by the input/output interface 110 and the CPU 102, and thereafter fed into GPU 104 and/or the processor unit 104A. Data objects stored in memory 106 are also updated.

Processes or programs for executing a render or a part of a render, such as a shader, execute directly on the GPU 104 and/or the processor unit 104A. This utilizes the graphical capabilities of the GPU 104 for computing a fast render. Responsive to each updated value fed into the GPU 104, a new render is calculated and outputted. This allows a near-real time feedback of user changes to values in a scene.

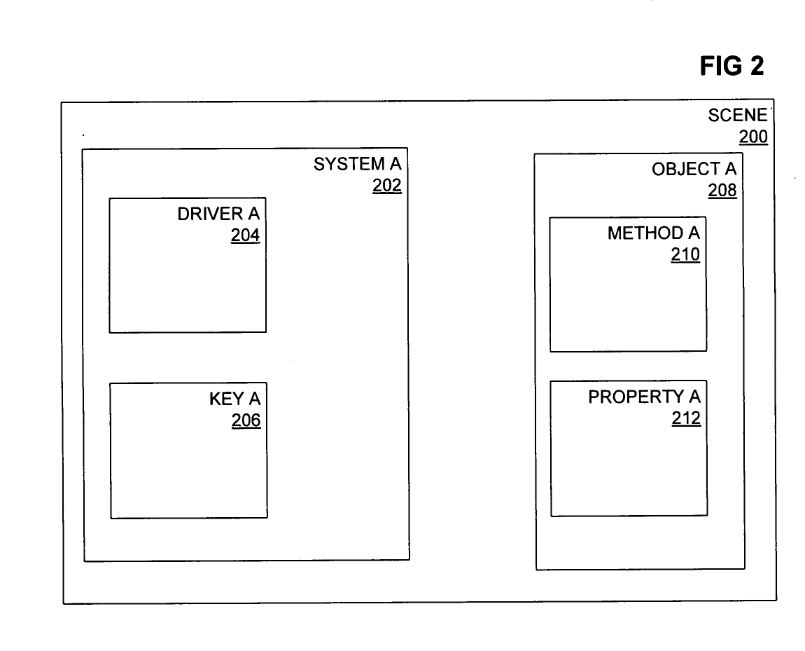

FIG. 2 illustrates an example data structure for providing fast calculation of a selected frame within an animation sequence. The data structure can be used on a workstation providing the three-dimensional visualization software and store the necessary data to perform user requested modifications, visualization of user-changes, and rendering of the sequence. The data structures can be optimized for minimal storage space, fast visualization and rendering, or any other performance characteristic or combination of performance characteristics.

In the example of FIG. 2, a three-dimensional visual sequence can be stored as a scene 200. The scene can include a system A 202 which can include a driver A 204 and a key A 206. The scene can include an object A 208, which can include a method A 210 and a property A 212. While only one system and one object are depicted, any number of systems and objects can be included in the scene. While only one driver and one key are depicted, any number of drivers and keys can be included in the system. While only one method and one property are depicted, any number of methods and properties can be included in the object.

In the example of FIG. 2, the scene 200 can store data representing a three-dimensional video sequence, including all objects and effects. The scene can be stored as a digital collection of data in memory for manipulation and processing. For example, the scene can be modified by user input. For example, the scene can be processed for visualization and rendering.

In the example of FIG. 2, the system A 202 can be an effect on an object within the scene. For example, an effect can be a surface texture, a light reflection characteristic, a material effect, etc.

In the example of FIG. 2, the driver A 204 stores a continuum of values across time associated with a property. For example, the driver A 204 can include values that vary during the length of the animation sequence or a subset of the animation sequence. For example, a strobe light object can have a rate of strobe property and strobe color property. The user can set the rate of strobe drive and the strobe color driver. During the animation sequence, the driver alters the model each frame over a period of time when the driver exists.

In the example of FIG. 2, the key A 206 can be, for example, a simple driver, representing a state in time. Keys store property values associated with objects in the system. Specifically, keys store a single value (or set of values) for a single moment in time during the animation sequence. For example, a light object can have a color property of “R:100 G:52 B:243” at time 0:00:01.5.

In the example of FIG. 2, the object A 208 can be, for example, an object depicted in the scene such as a character or a prop. Each object can include methods that act on it, such as modifying it, and properties that store its state.

In the example of FIG. 2, the method A 210 can be, for example, a display method associated with the object. For example, the display method can retrieve the object's state from the properties and properly display the object. In an alternative, a GUI generation display method can generate and display a GUI configured to receive user input regarding possible modifications to the object.

In the example of FIG. 2, the property A 212 can be, for example, a property associated with the object. For example, properties of the object can include location within the scene, color, association with other objects, animation or movement during the sequence, etc.

In the example of FIG. 2, in operation, the objects and systems of the scene are retrieved and displayed using associated display methods. The scene is designed and stored in an objected-oriented manner; thus allowing different layers of abstraction at each level of programming.

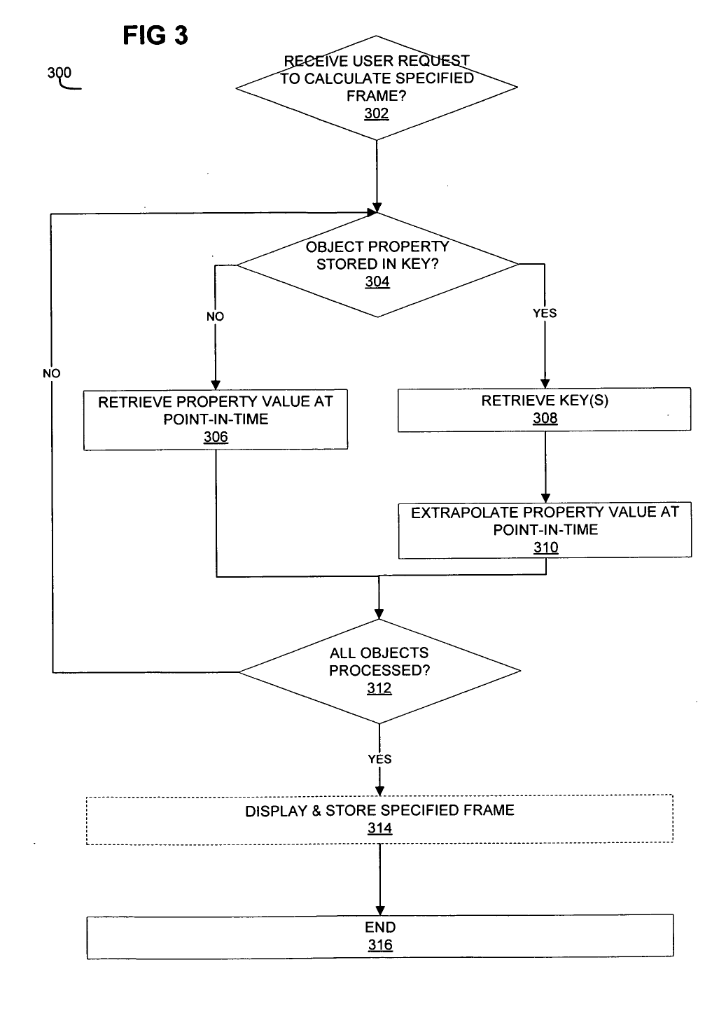

FIG. 3 illustrates an example procedure 300 for providing fast calculation of a selected frame within an animation sequence. The procedure can execute on a system as depicted in FIG. 2 to calculate a specified frame within an animation sequence. Multiple frames can be calculated to produce the animation sequence.

In 302, the workstation determines whether a user request has been received to calculate a specified frame. For example, a user can input a user command to render a specific frame or sequence of frames within the animation sequence.

In 304, the workstation determines whether a requested object property is stored in a driver or a key. If the object property is stored in a driver, the workstation proceeds to 306. If the object property is stored in a key, the workstation proceeds to 308.

The animation sequence can be stored as a series of objects, the objects representing a three-dimensional model. Each object includes properties that affect the appearance of the animation sequence.

In 306, the workstation retrieves a property value at a point in time of the specified frame from the driver. As discussed above, the driver stores a continuum of values associated with a property, varying across time of the animation sequence. The workstation retrieves a value from the driver at the point in time of the specified frame.

If the driver does not include a value for the point in time of the specified frame, the workstation can use a default value for the property, extrapolate a value from prior or subsequent points in time, or some other method to calculate a property value.

In 308, the workstation retrieves property values from keys of the object. As discussed above, keys store a single value or sets of values representing a property value at a point in time.

In 310, the workstation extrapolates a property value at the point in time of the specified frame from the keys retrieved in 308. If the specified frame is at a point in time that matches one of the keys, the key value is used.

If the specified frame is at a point in time between multiple keys, a blending function can be used to quickly calculate a property value even though none of the keys are associated with the specified frame point in time. The blending function can be a linear or exponential averaging function, or some other function that outputs a blended result.

In 312, the workstation determines whether all software objects have been processed. An animation sequence can include multiple software objects, each with its own associated properties. The workstation repeats the procedure until all objects have been processed.

In 314, the workstation optionally displays and stores the specified frame that has been calculated. It will be appreciated that the entire animation sequence or a subset of the animation sequence can be rendered by rendering a desired number of specified frames from the software objects.

In 306, the workstation exits the procedure.

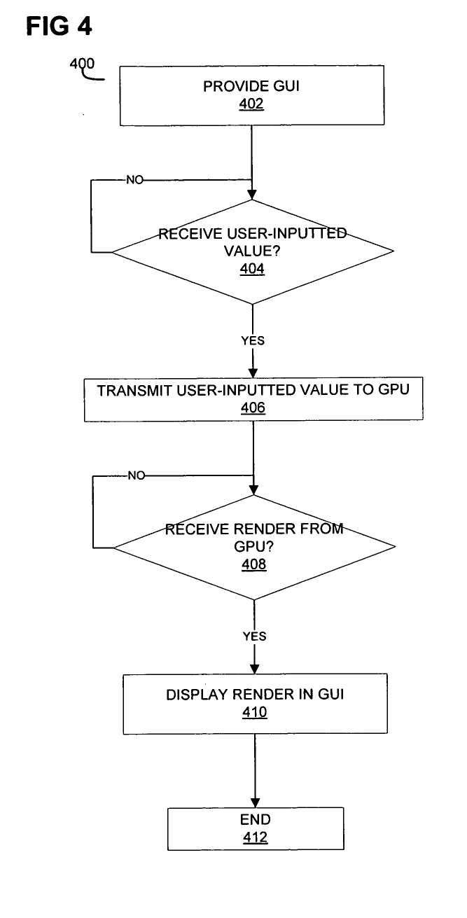

FIG. 4 illustrates an example procedure for providing near real-time rendering responsive to user-inputted values of a three-dimensional scene. The procedure can execute on a system as illustrated in FIG. 1. The procedure can utilize data objects as illustrated in FIG. 2. The procedure provides a GUI, into which a user inputs new or revised scene values and displays a near real-time render of the scene responsive to the user-inputted values. The user can view any frame within the rendered animation from any point of view, and also view an associated animation clip. By providing a near real-time render, the user can easily visualize changes made to scene values during scene creation or editing.

In 402, the workstation can provide a GUI. For example, the GUI includes input fields for receiving user-inputted values, output fields for displaying scene properties, and a render window for displaying a current render of the scene. For example, the render window can display the scene from any point in time within the animation sequence and from any point of view within the three-dimensional space.

In 404, the workstation can test whether a user-inputted value is received. The GUI awaits user inputs and converts user-inputted values into scene values, if necessary. The GUI also stores the user-inputted value into a data object in an accessible memory, if necessary.

In 406, the workstation transmits the received user-inputted value to the GPU. For example, the GPU can have an accessible register accessible to the GUI. Alternatively, the user-inputted value can be stored in memory, and the GUI automatically prompts the GPU to compute a render. The GPU can check the memory for the user-inputted value before executing the render.

Alternatively, the user-inputted value can be transmitted to any processing device within the workstation. Performance improvements can be obtained by computing the render on a special purpose processor configured for performance graphics-related computations.

In 408, the workstation tests whether a render is received from the GPU. The GPU can immediately compute a GPU responsive to receiving the user-inputted values from above. By computing the render on a GPU, very fast render times can be achieved due to the special hardware and processing capabilities available.

It will be appreciated that the GPU can be part of the workstation. It will be appreciated that the render can be computed by any other processing device accessible to the workstation.

The GPU can compute the render responsive to user-indicated preferences. For example, certain aspects of the scene can be ignored to improve rendering performance, such as lighting, shading, texturing, or other aspects.

In 410, the workstation displays the render to the user in the GUI. For example, a desired frame of the render from a desired point of view can be displayed in the render window to the user, discussed above. The user can select the desired frame and the desired point of view. The user can also view an animation associated with the scene, or a portion of the animation.

In 412, the procedure ends.

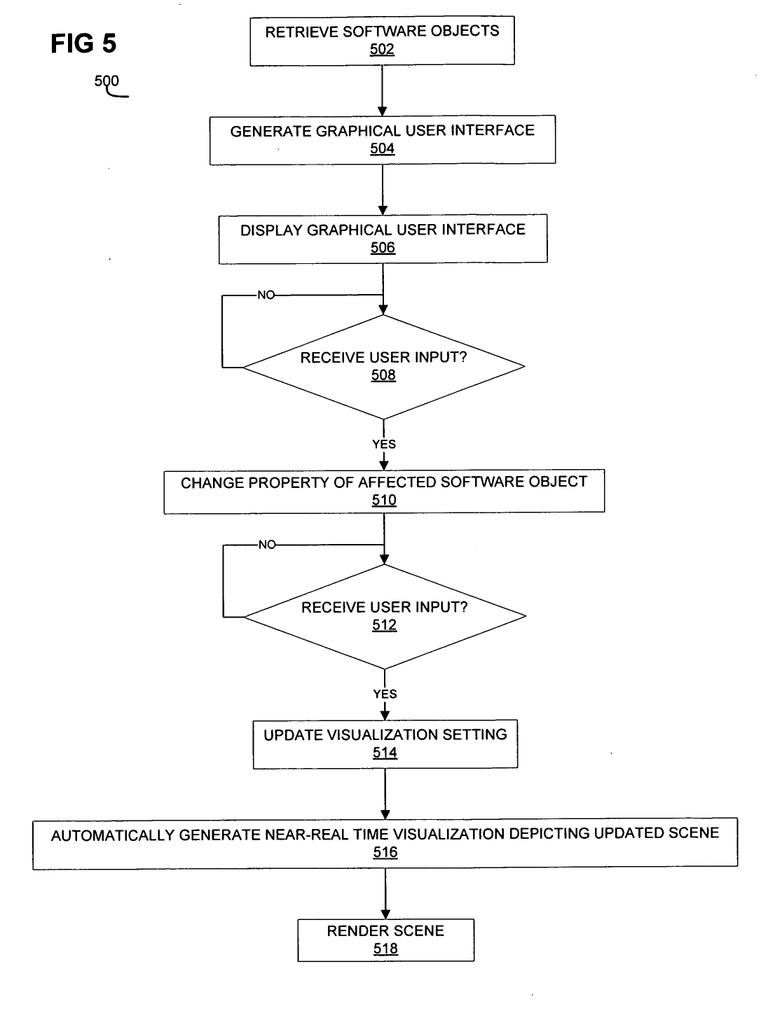

FIG. 5 illustrates an example procedure 500 for providing a three-dimensional visualization software. The procedure may execute on a workstation and generate a GUI to interface with a user in modifying a scene. The scene may be retrieved from memory and visualized by the three-dimensional visualization software responsive to user changes of objects in the scene. The procedure may also render the scene into a video sequence after the user completes any desired modifications.

In the example of FIG. 5, in 502, the workstation may retrieve software objects from memory. For example, the software objects may be stored in a scene data structure on a mass storage and retrieved into memory for quick access by the workstation. Software objects may include objects depicted in the scene as well as systems that represent effects in the scene, and anything else that is depicted in the scene.

In the example of FIG. 5, in 504, the workstation may generate a GUI. For example, the workstation may access a list associating each software object type with a display method. For every software object to be depicted, an associated display method based on the software object type may be invoked. This may create a uniform interface, where all software objects of the same type are displayed with a similar GUI interface.

In an alternative, each software object may include a display method that is invoked to display the software object. This allows customized display methods to be created that uniquely serve the associated software object. In this way, the scene may be easily displayed by simply invoking the display method associated with each software object within the scene. In an alternative, other methods may be used to generate the GUI.

In the example of FIG. 5, in 506, the workstation may display the generated GUI. The GUI may be as generated above and displayed out of an input/output interface on a display monitor to the user.

In the example of FIG. 5, in 508, the workstation may test whether a user input regarding changes or modifications to be made to at least one of the software objects has been received. For example, the GUI may offer interfaces to the user for changing or modifying various properties of software objects in the scene. If user inputs are received, the workstation may proceed to 510 to process the user input. If no user inputs are received, the workstation may remain at 508 and wait for user inputs or skip forward to 516.

In the example of FIG. 5, in 510, the workstation may change a property of an affected software object responsive to the user input. For example, the user input may increase or decrease a property value such as light brightness, fog transparency, or other properties via the GUI. In an alternative, a group selection feature may allow the user to modify properties of related objects simultaneously.

In the example of FIG. 5, in 512, the workstation may optionally test whether a user input regarding changes to a visualization setting has been received. For example, visualizing the scene based on the changed software objects may be executed on a GPU for efficient performance. Visualization may be controlled by various settings accessible through the GUI that affect visualization performance, such as complexity of the visualized scene. If user inputs are received, the workstation may proceed to 514, where the affected visualization setting is changed. If no user inputs are received, the workstation may remain at 512 waiting for the user inputs or skip forward to 516.

In the example of FIG. 5, in 514, the workstation may optionally update the visualization setting responsive to the user inputs. The visualization setting may be changed as above to alter the complexity of the visualized scene.

In the example of FIG. 5, in 516, the workstation may automatically generate near-real-time visualization depicting the updated scene, reflecting any user changes received. The visualization may be optimized for execution on the GPU for fast performance. The visualization may occur in near-real-time, for example, at more than one frame per second, and allow the user to immediate visualize any impact of the changes or modifications made above to the software objects. If additional user inputs are necessary, the workstation may return to 508 and await the user inputs.

In an alternative, the visualization may be executed on the CPU. In an alternative, the visualization may be executed on a combination of processors.

In the example of FIG. 5, in 518, the workstation may optionally render the scene in a desired quality. The rendering may be executed responsive to a user instruction to render the final scene. For example, the rendering may be similar to the visualization and execute on the GPU, the CPU, or a combination of processors within and outside the workstation. For example, rendering may be executed at a high-performance rendering server.

In the example of FIG. 5, in operation, automatic near-real-time visualization may be generated and displayed to the user responsive to user changes and modification of the scene. For example, the user may update a lighting property in the scene, and immediately see the impact of the change. The user may reposition objects, cameras, and lights within the scene, and immediately visualize the changes. This allows a much more intuitive interaction with the three-dimensional visualization software.

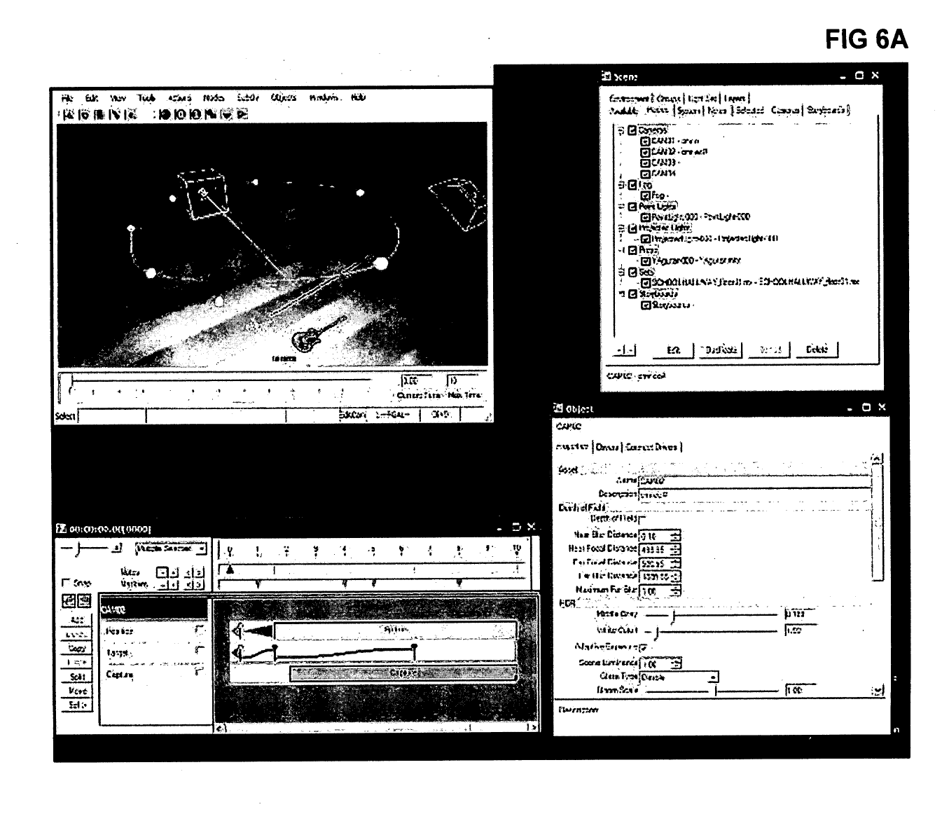

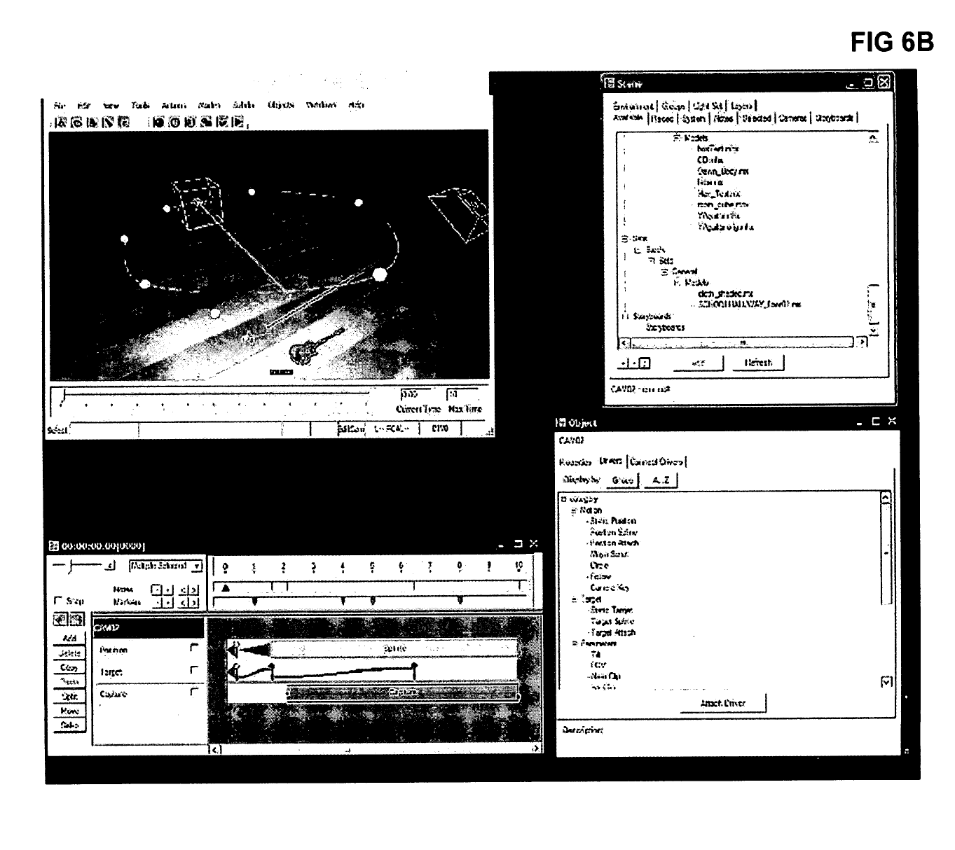

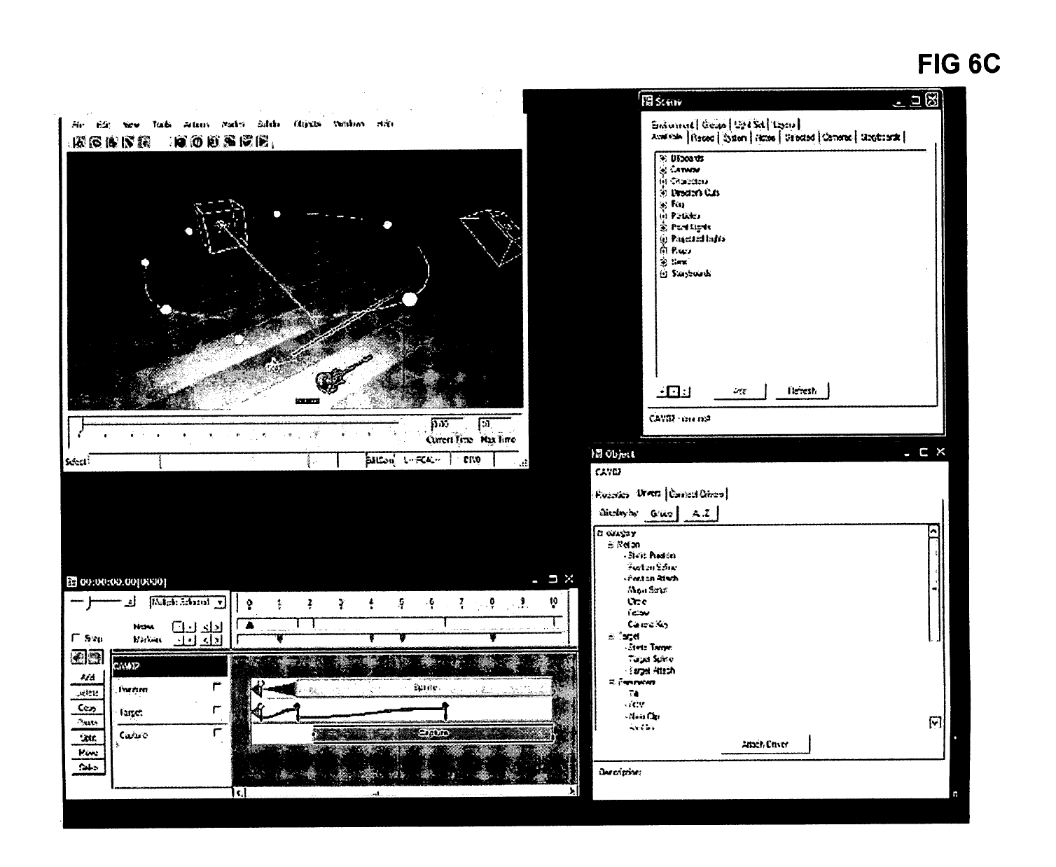

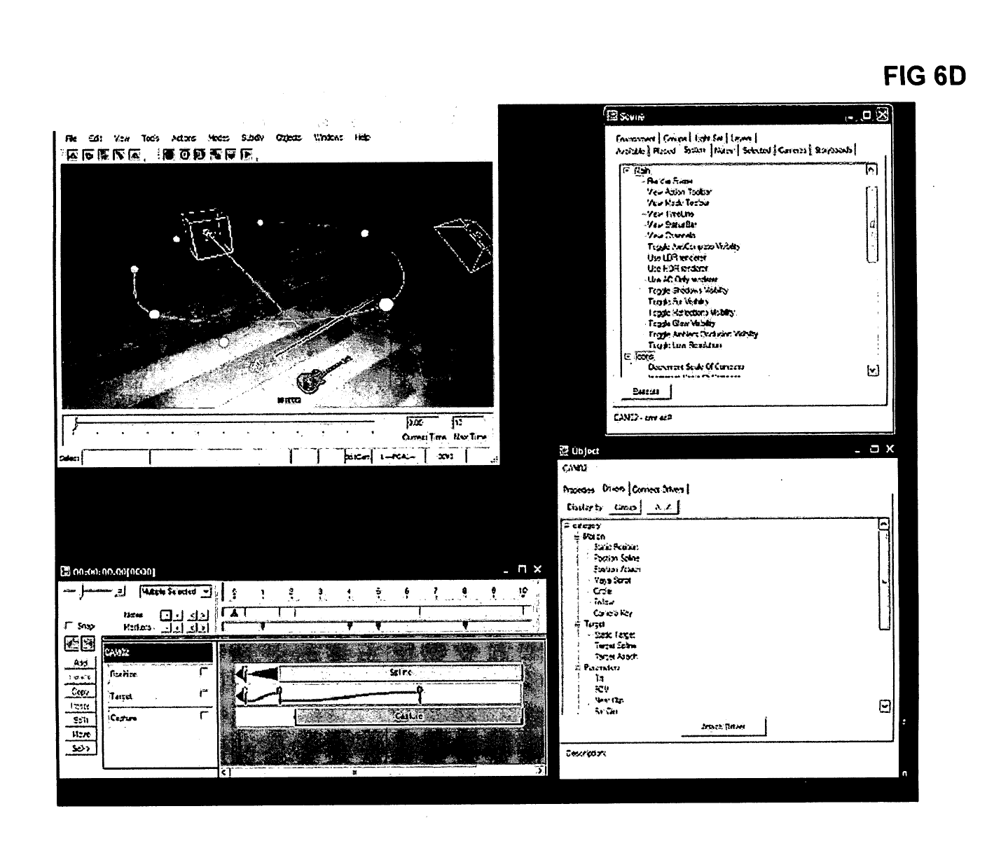

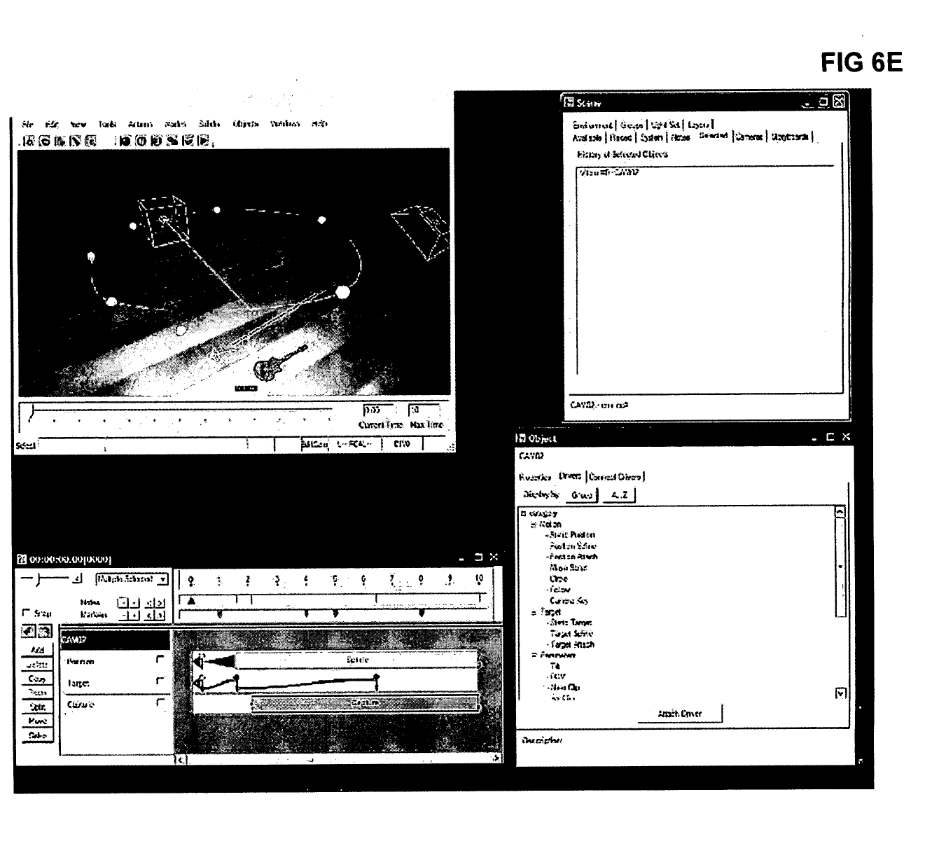

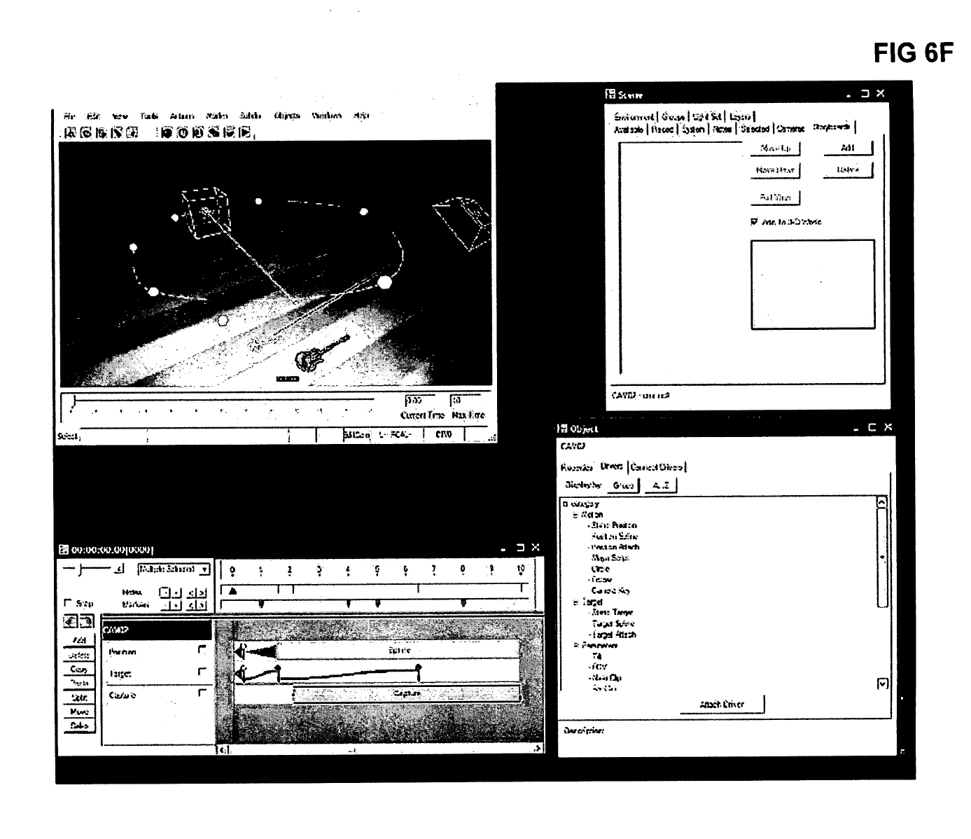

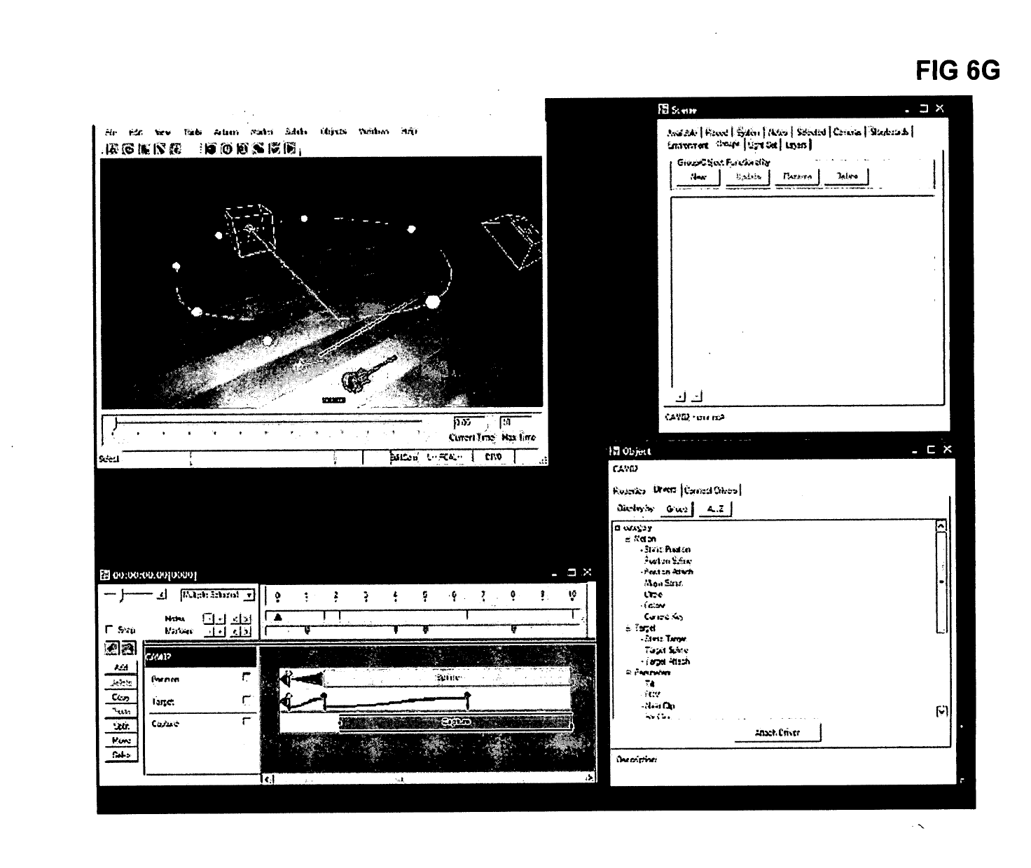

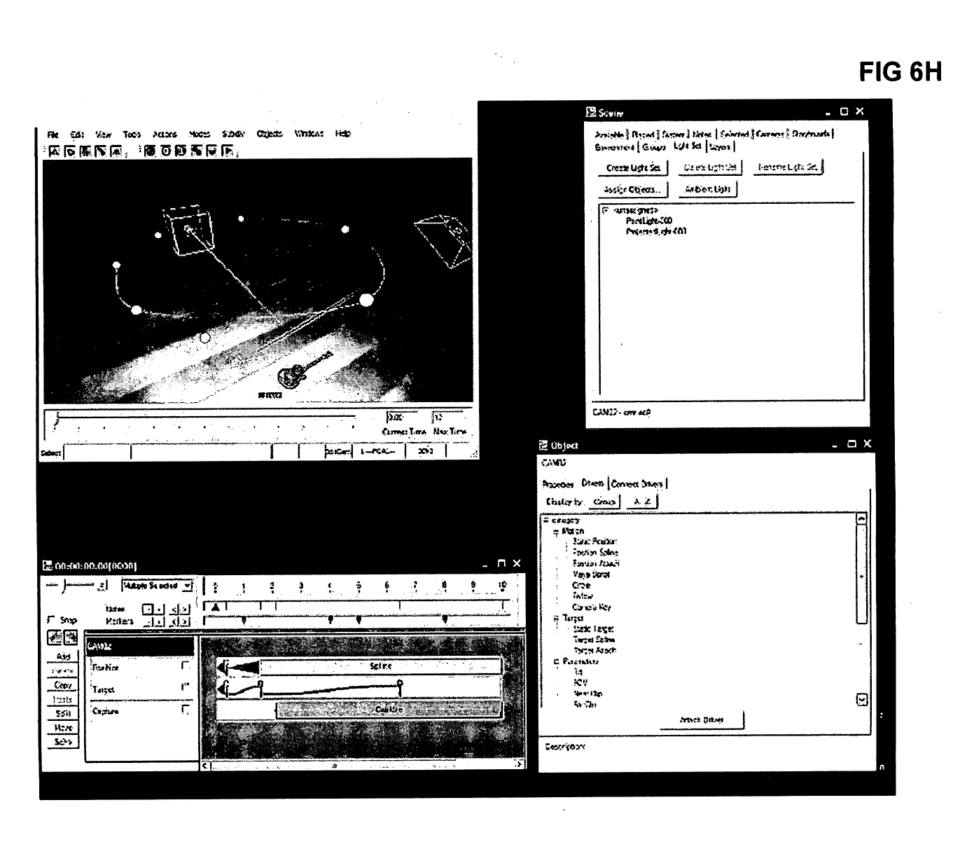

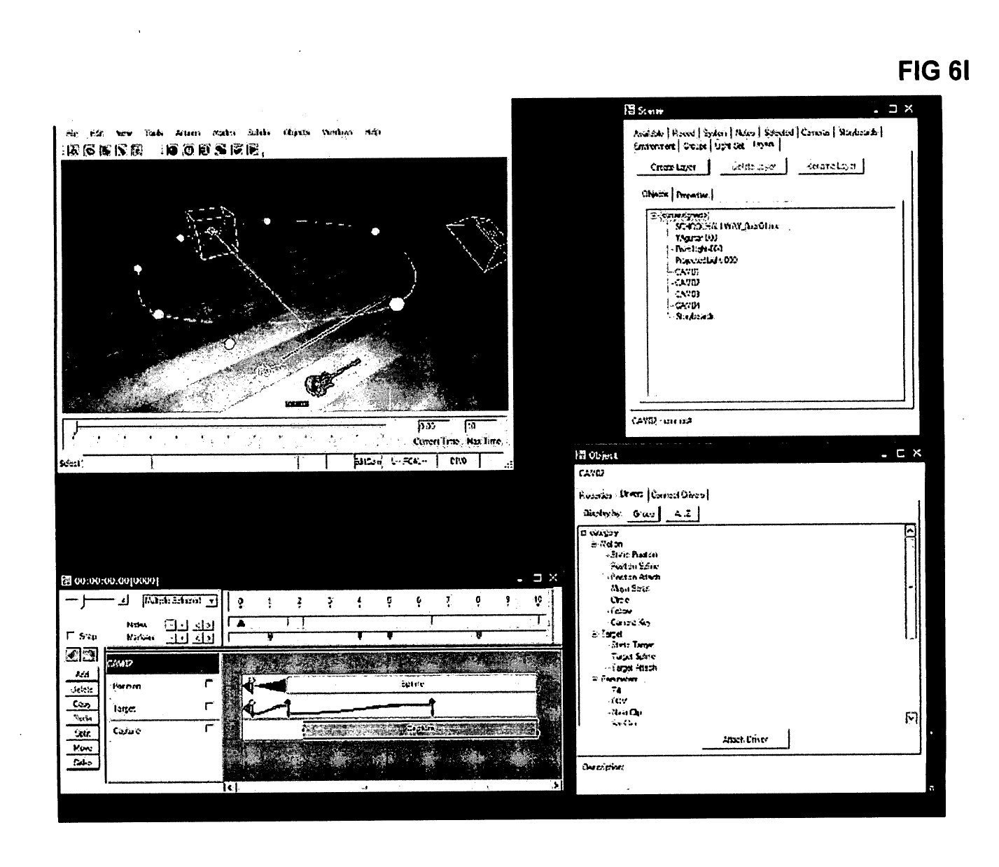

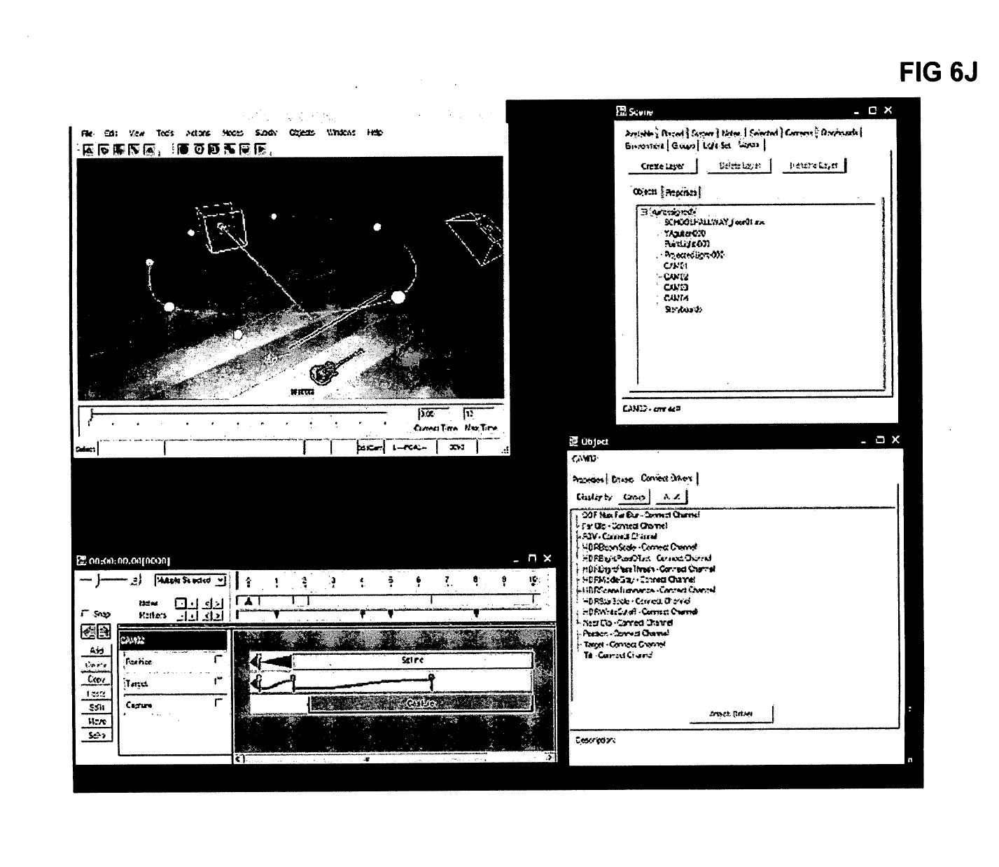

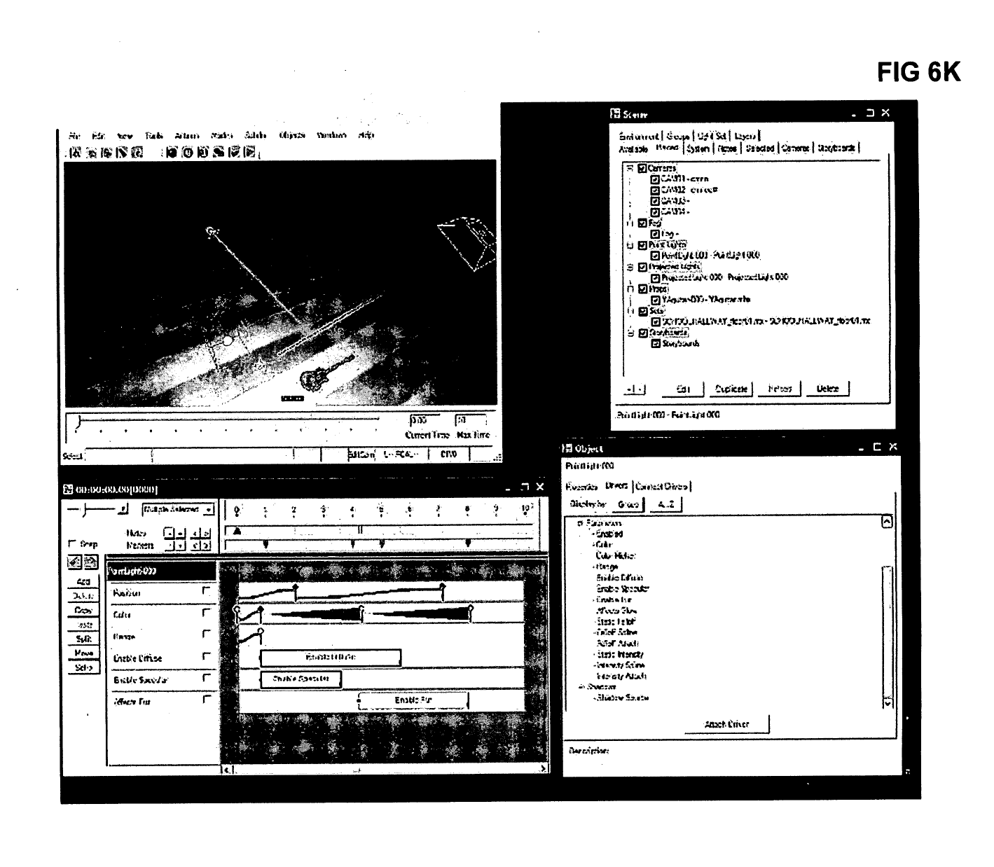

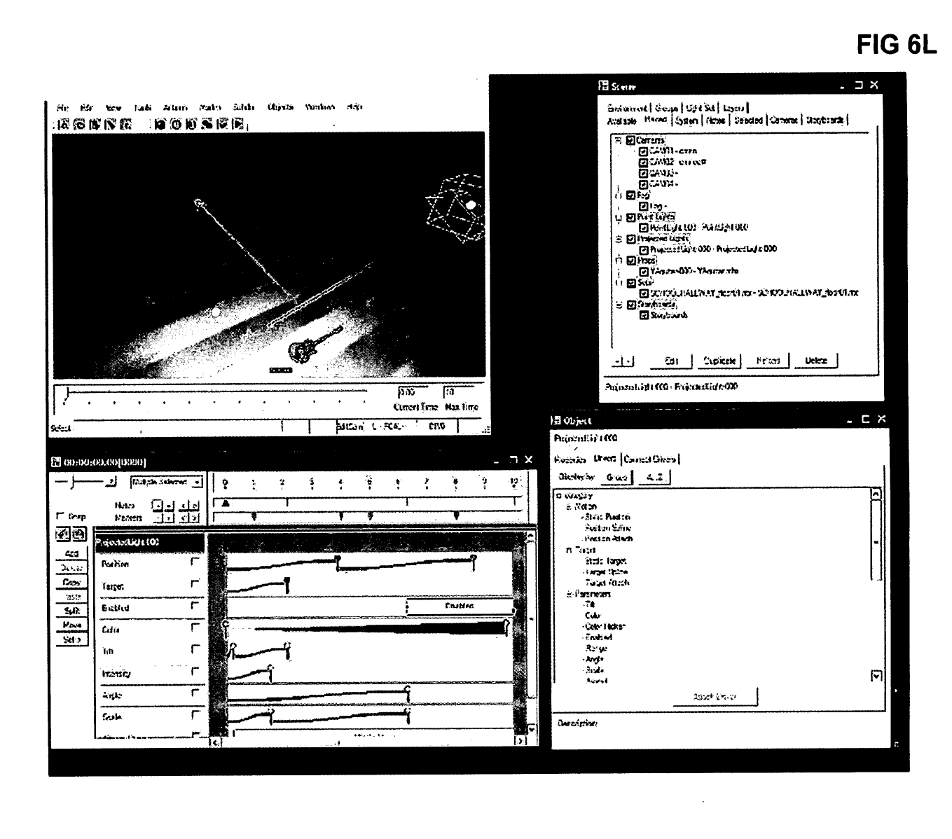

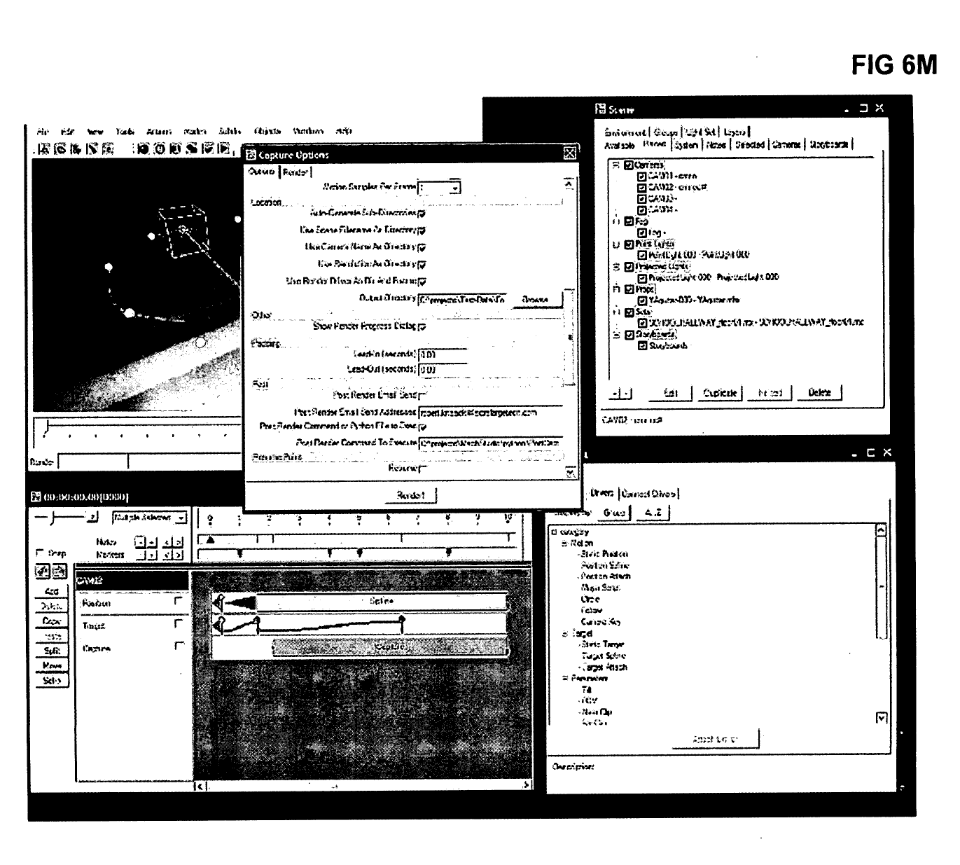

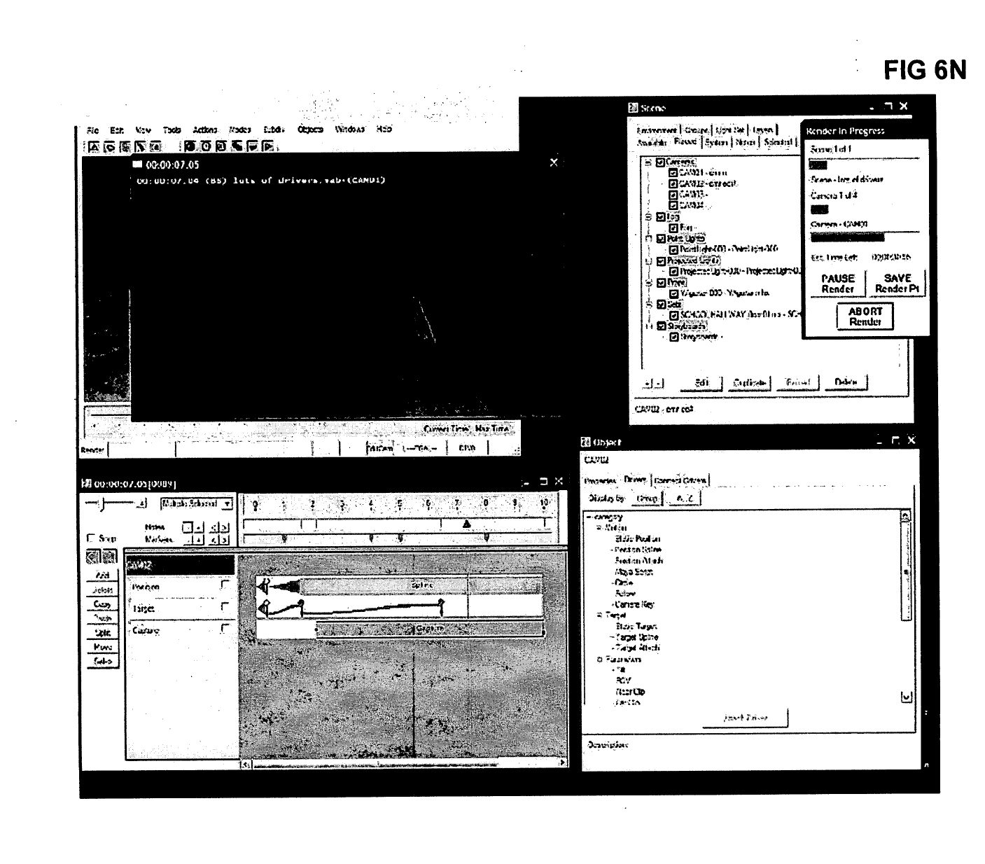

FIG. 6A illustrates an example screen shot from a three-dimensional visualization software. The screen shot may include a visualization window that displays the current scene and provide a GUI for the user to manipulate to provide different views of the scene. A click-and-drag interface may be used to change a camera position, allowing the user to view the scene from different angles.

In the example of FIG. 6A, depicted objects in the visualization window may be moved and otherwise modified responsive to user inputs. The screen shot may include a time line window with channels and keys for one or more cameras that are movable throughout the scene during a sequence. Each key may define a state in the sequence, and the remainder of the sequence may be extrapolated from the one or more defined keys in a scene.

In the example of FIG. 6A, the screen shot may include a scene window with a list of placed systems, such as cameras, fog effect, lights, etc. The systems may be organized into groups and subgroups, and the GUI may allow a user to select or deselect systems for depiction in the visualization window.

In the example of FIG. 6A, the screen shot may include an object window describing properties of the object. A GUI may provide an interface for the user to modify properties of the object, such as an object name and description. In addition, object type-specific properties may be displayed. For example, a camera object may include camera properties such as blur distance, focal distance, and other properties that modify how the scene will be perceived by the select camera.

In the example of FIG. 6A, any changes made by the user through the GUI will be automatically visualized in the visualization window. For example, changes to object positions, object property settings, system positions and system settings may change how a scene is depicted. By providing immediate and automatic visualization of any changes, the three-dimensional visualization software facilitates a user's creative process without interrupting a design flow.

FIG. 6B illustrates another example screen shot from a three-dimensional visualization software. The screen shot may include a scene window with available systems for placement in the scene. The systems may be displayed in a tree structure and organized by groups and subgroups. The GUI may allow the user to select a system to be clicked-and-dragged into the visualization window. In addition, the GUI may allow the user to organize the systems into groups and subgroups. As discussed above, changes made to the scene may be visualized immediately in the visualization window.

FIG. 6C illustrates another example screen shot from a three-dimensional visualization software. The screen shot may include a scene window with available systems in a collapsed tree structure. The scene window may be similar to above, but with all the groups collapsed. As discussed above, changes made to the scene may be visualized immediately in the visualization window.

FIG. 6D illustrates another example screen shot from a three-dimensional visualization software. The screen shot may include drivers and properties of the selected system. Each system may include one or more drivers and properties, which may be displayed in the GUI and manipulated by the user. As discussed above, changes made to the scene may be visualized immediately in the visualization window.

FIG. 6E illustrates another example screen shot from a three-dimensional visualization software. The screen shot may include a currently selected system. The selected system may be highlighted or otherwise indicated in the visualization window. The screen shot may further display a history of selected objects for the convenience of the user during an editing session. As discussed above, changes made to the scene may be visualized immediately in the visualization window.

FIG. 6F illustrates another example screen shot from a three-dimensional visualization software. The screen shot may include a storyboard GUI. As discussed above, changes made to the scene may be visualized immediately in the visualization window.

FIG. 6G illustrates another example screen shot from a three-dimensional visualization software. The screen shot may display a group GUI, which allows the user to place related systems and objects into groups. For example, this may facilitate easy modification of an entire group without requiring the user to manually select each system or group for modification. As discussed above, changes made to the scene may be visualized immediately in the visualization window.

FIG. 6H illustrates another example screen shot from a three-dimensional visualization software. The screen shot may include a light set GUI that allows the user to modify and change the lighting used in the scene. Each light system may be included as a set, and ambient light settings may be modified. Example light systems may include a sun-object, a pin light, a spot light, or other lighting systems. Each light system may include properties that change how the lighting is projected within the scene. As discussed above, changes made to the scene may be visualized immediately in the visualization window.

FIG. 6I illustrates another example screen shot from a three-dimensional visualization software. The screen shot may include a layers GUI allowing users to modify layers in the scene. For example, objects and systems may be associated together in a layer. Each layer may be a collection of related objects and systems that can be manipulated as a unit by the user. For example, the user may change a position of the layer or modify properties of objects within the layer. As discussed above, changes made to the scene may be visualized immediately in the visualization window.

FIG. 6J illustrates another example screen shot from a three-dimensional visualization software. The screen shot may include an object window with object properties. For example, this may display various properties and channels associated with the object. As discussed above, changes made to the scene may be visualized immediately in the visualization window.

FIG. 6K illustrates another example screen shot from a three-dimensional visualization software. The screen shot may include a time line window with a system such as a point light. The point light system may be modified and moved via the GUI as depicted. As discussed above, changes made to the scene may be visualized immediately in the visualization window.

FIG. 6L illustrates another example screen shot from a three-dimensional visualization software. The screen shot may include a time line window with a system such as a projected light system. This may be similar to the GUI displaying the point light system above. As discussed above, changes made to the scene may be visualized immediately in the visualization window.

FIG. 6M illustrates another example screen shot from a three-dimensional visualization software. Responsive to a user input indicating a desire to render the scene into a sequence, a capture options window may be displayed with rendering options for user selection. The user may select options and input values that control the rendering before executing the render process. For example, the render process may execute on the workstation, or be outsourced to a rendering server over a network.

FIG. 6N illustrates another example screen shot from a three-dimensional visualization software. The final rendered result of the scene may be displayed to the user as a video clip for viewing. A progress window may display the progress of the render, as well as various input options such as pause, save, or abort the rendering process.

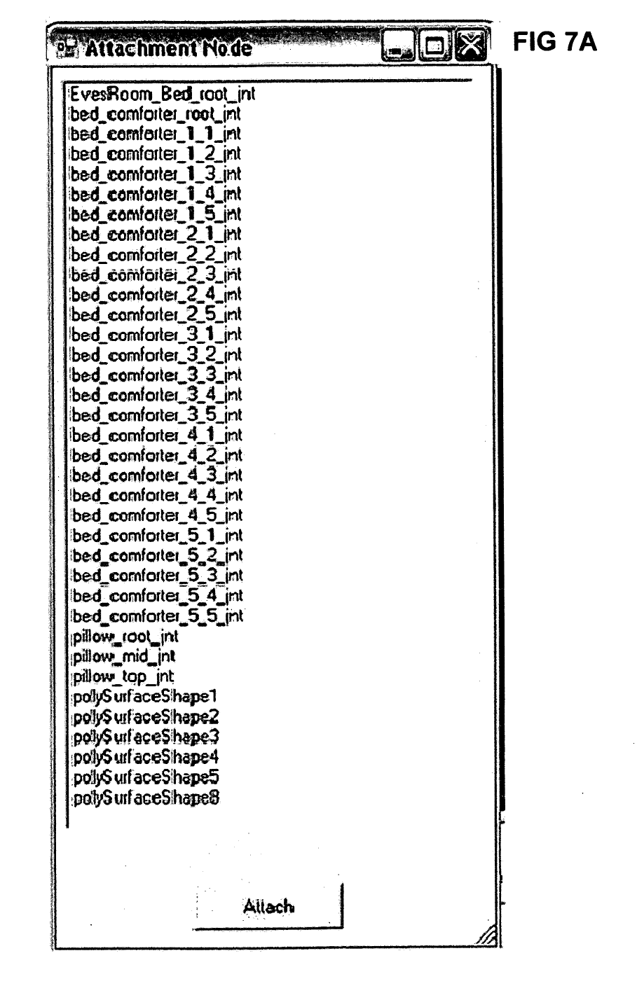

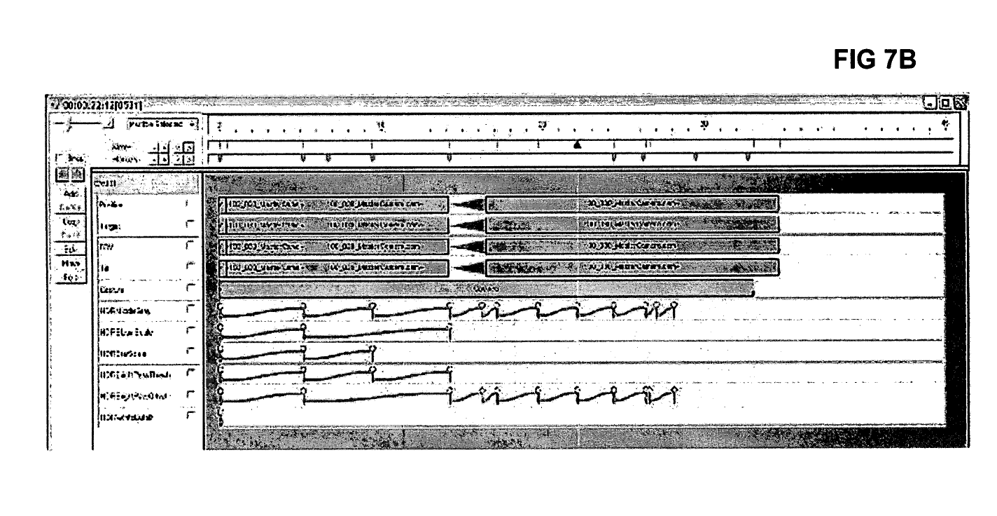

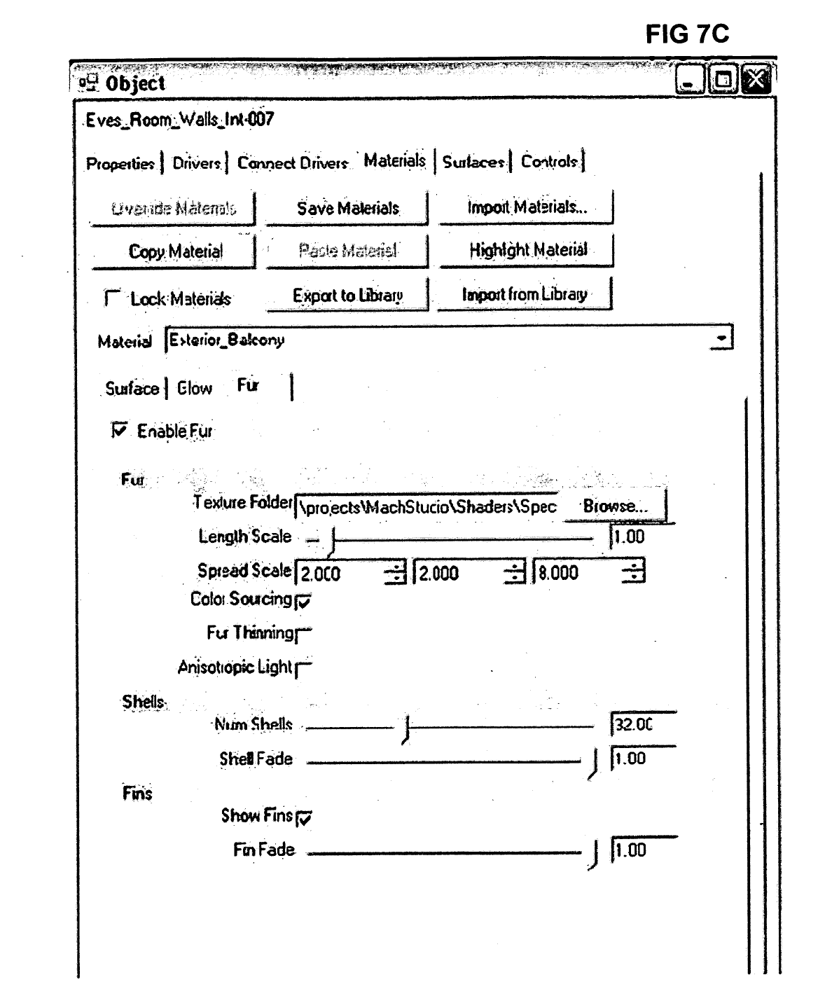

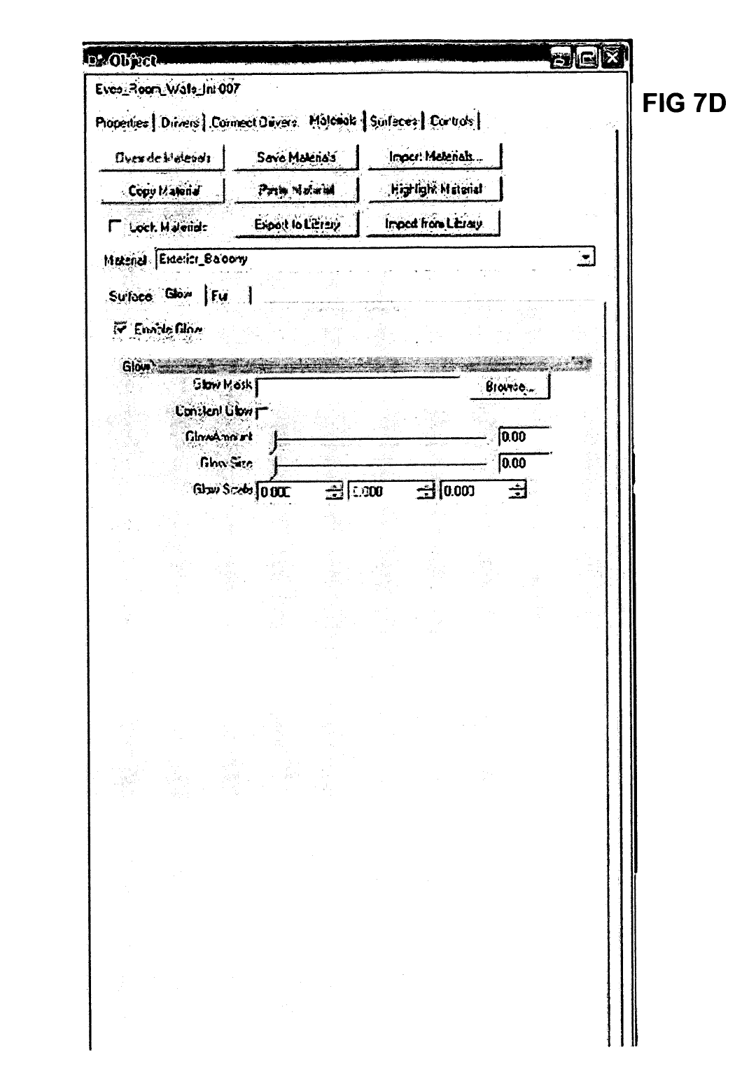

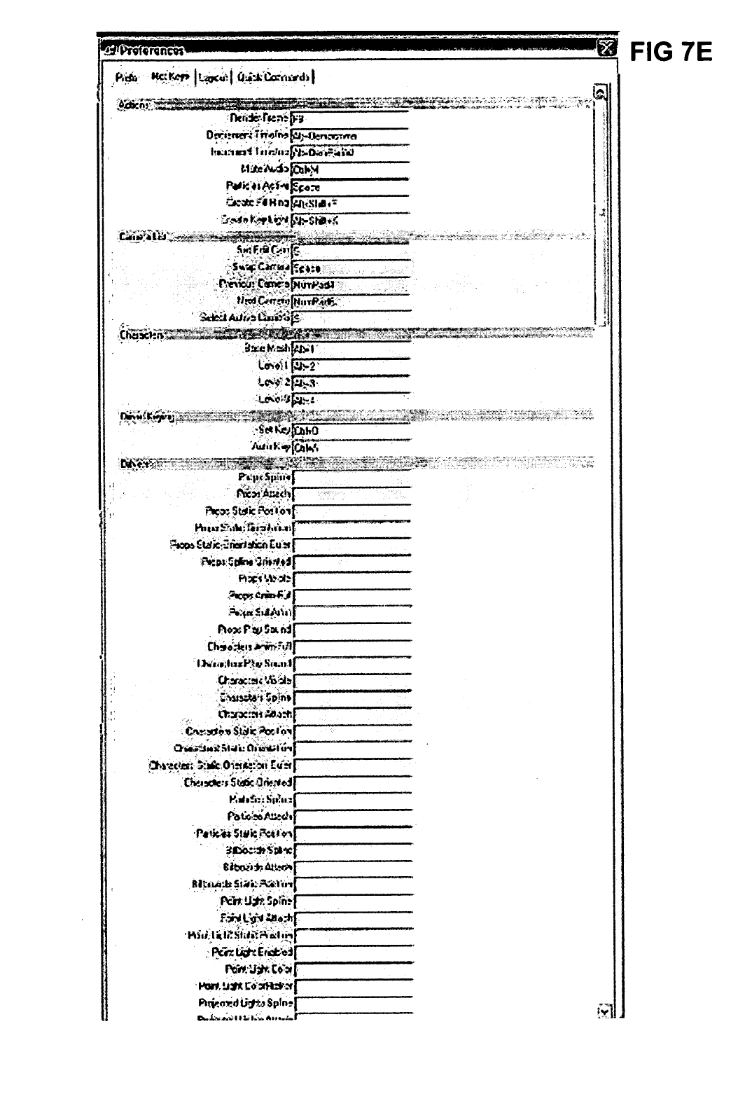

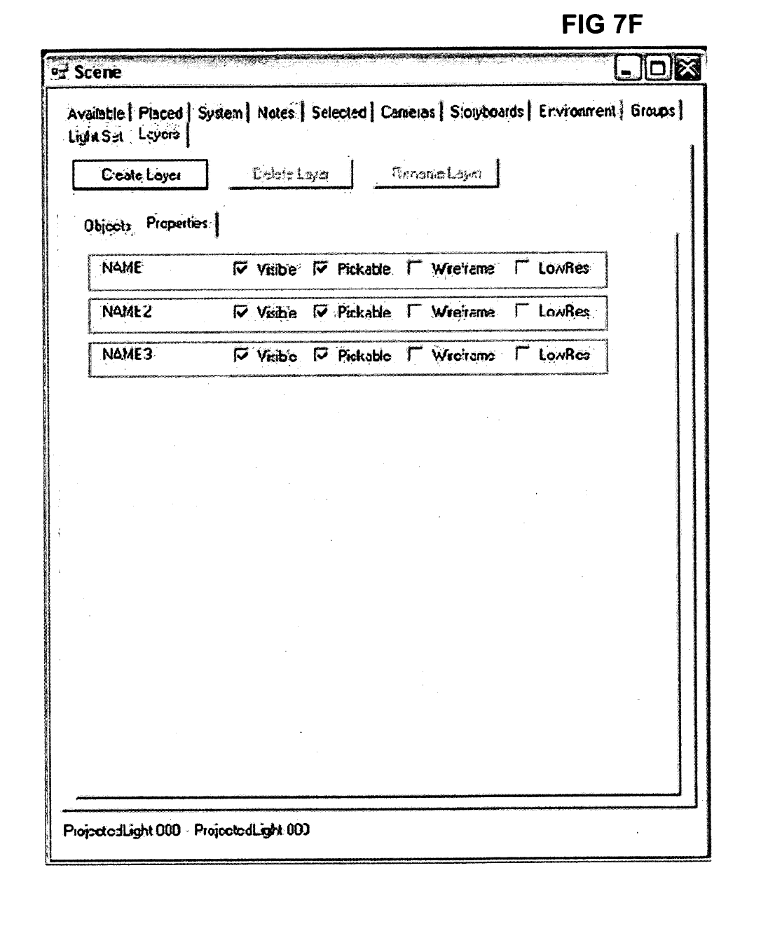

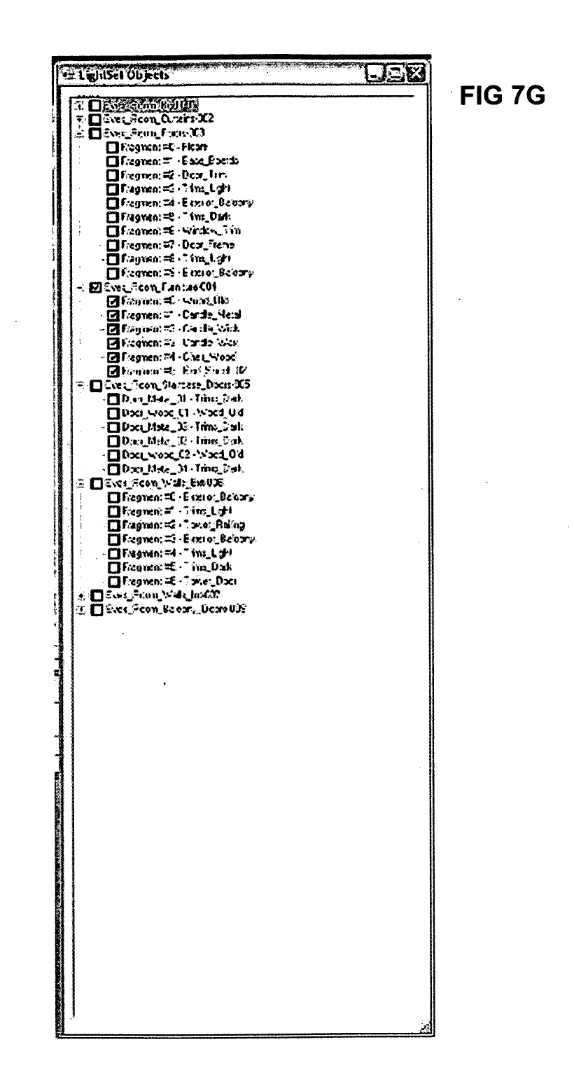

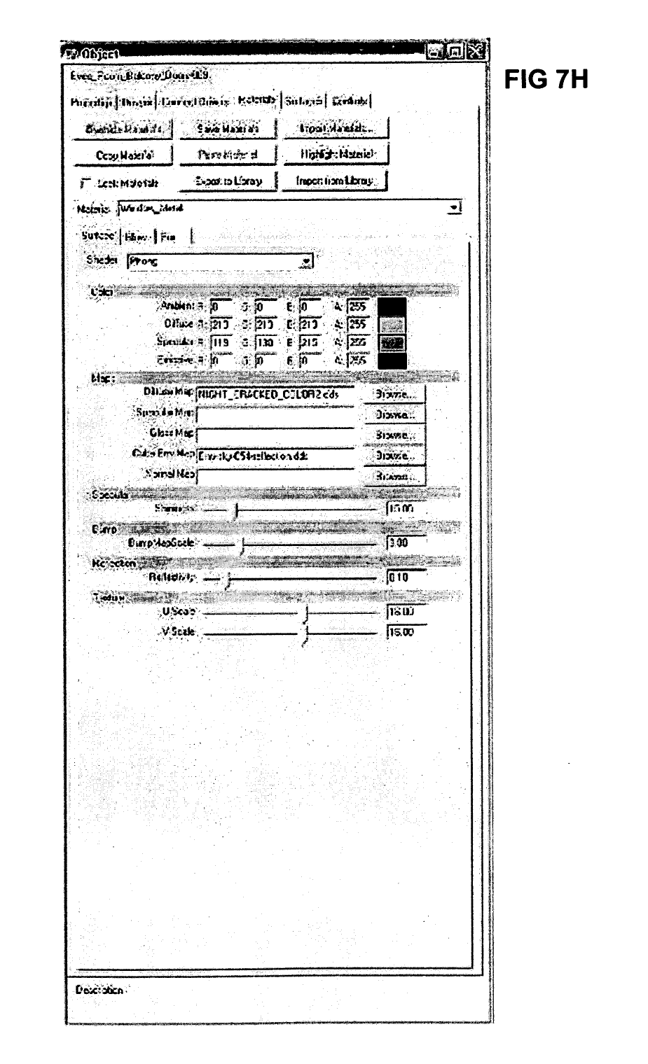

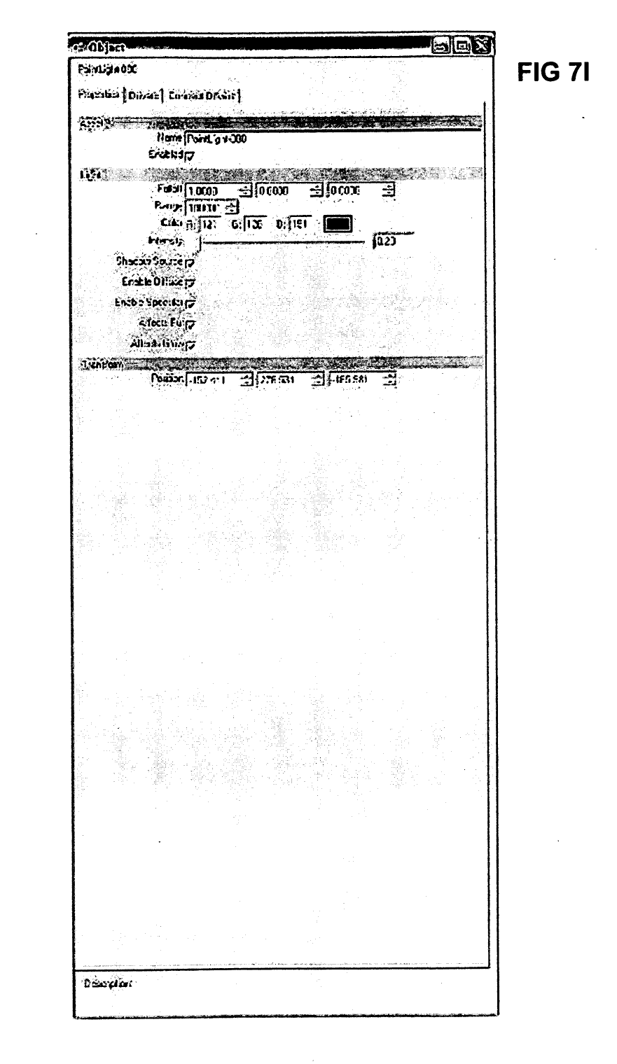

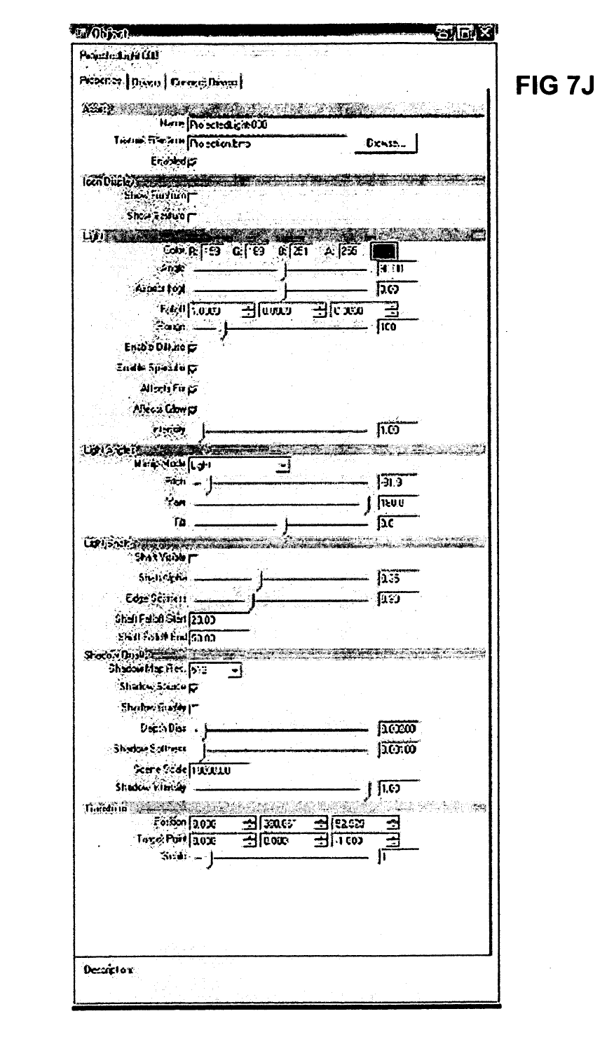

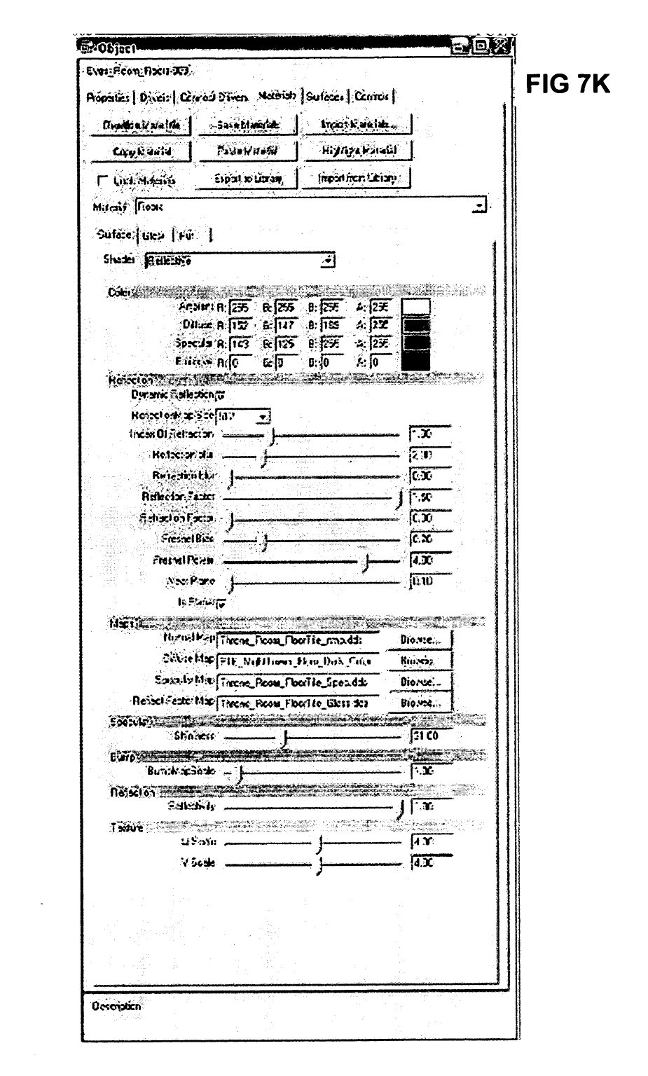

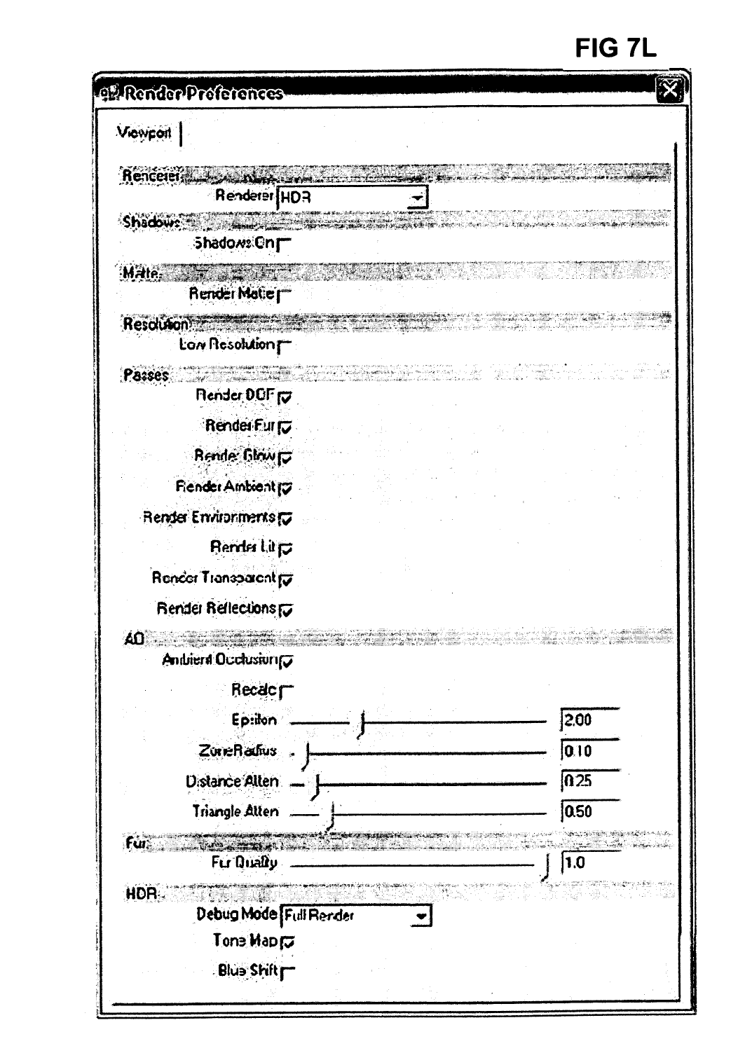

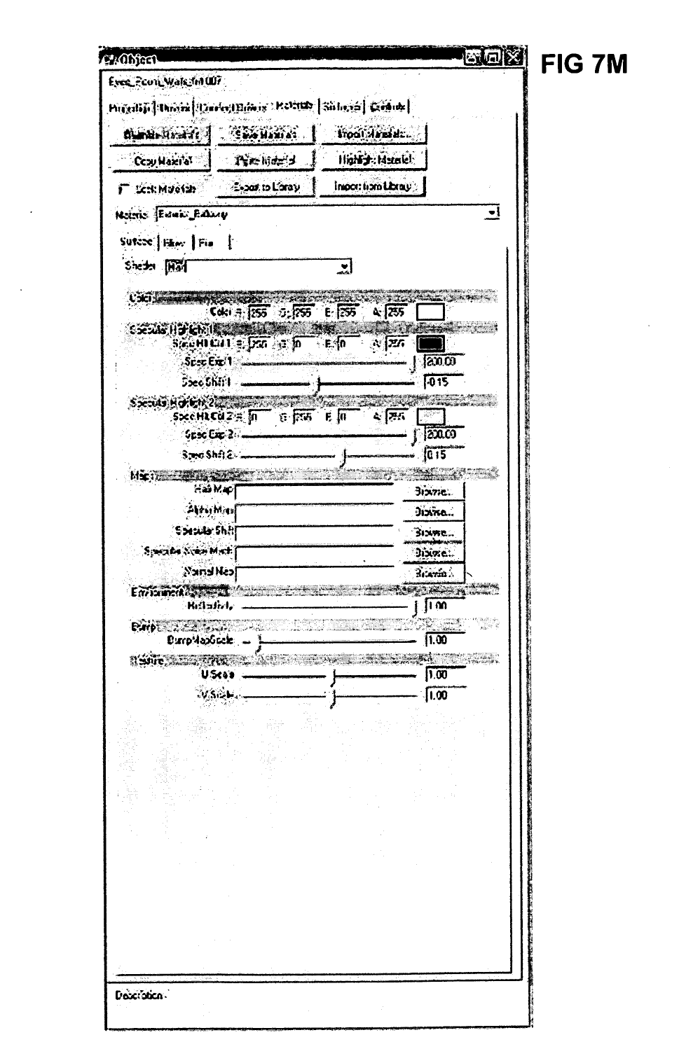

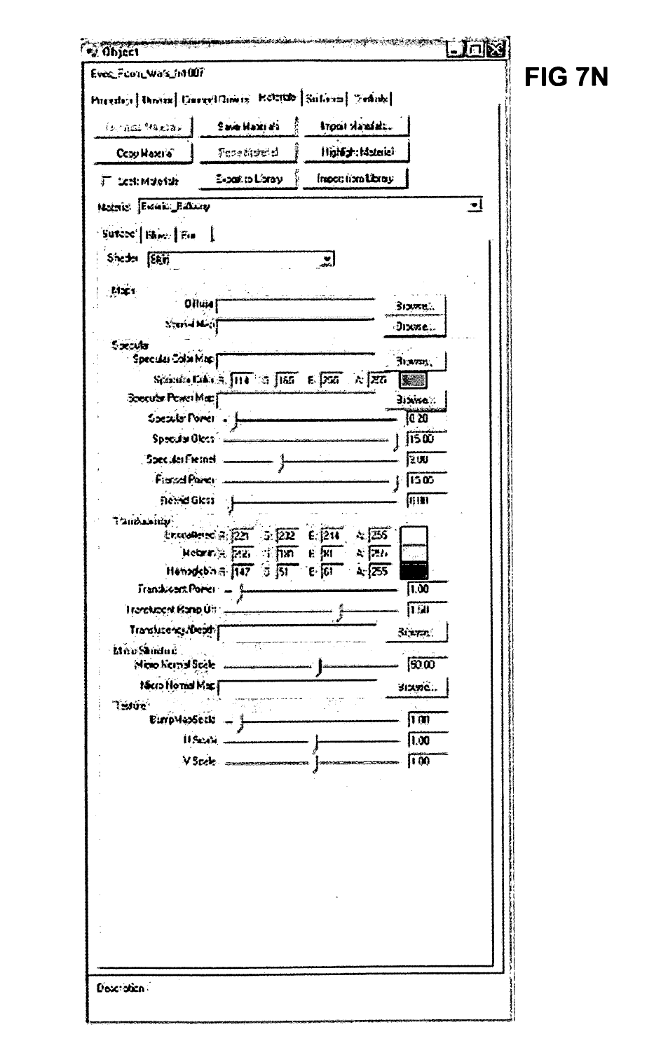

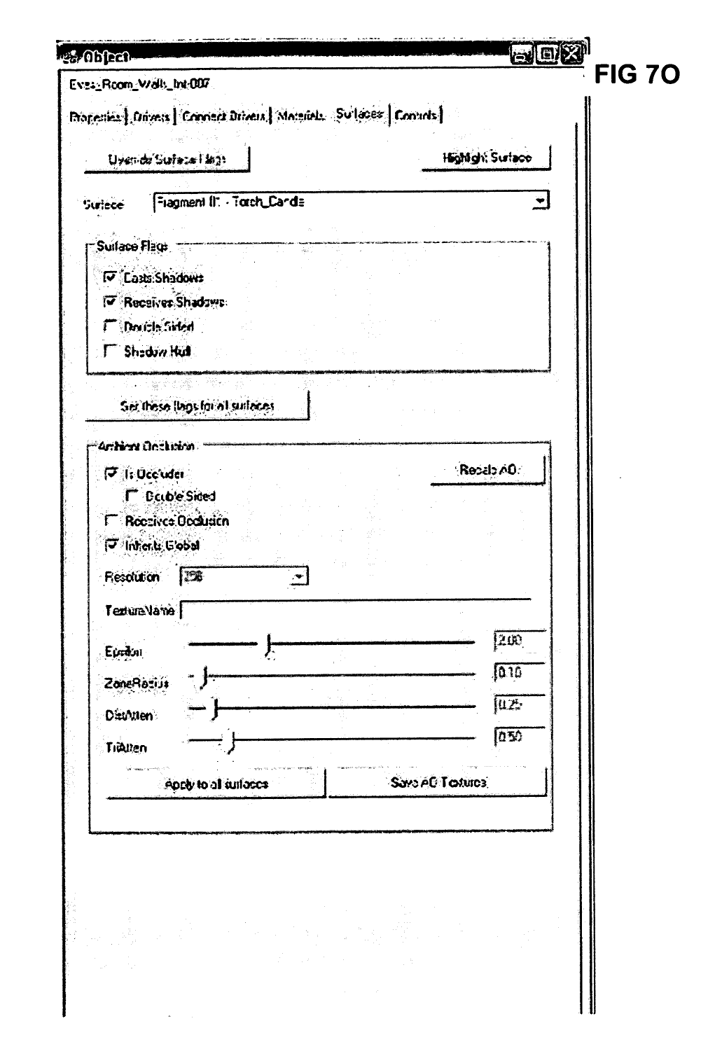

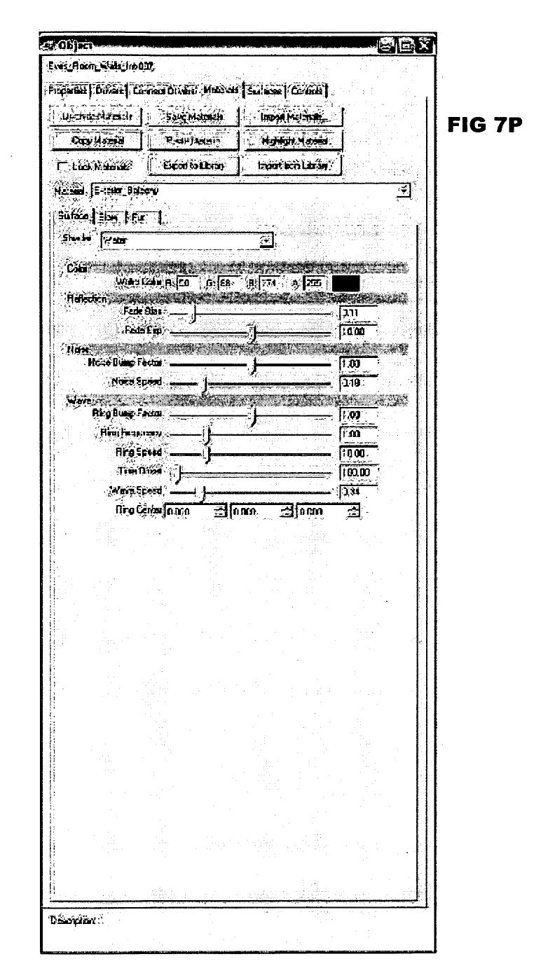

FIG. 7A illustrates an example screen shot of an attachment node interface in a three-dimensional visualization software. The screen shot may include a list of all nodes attached to an object. Nodes may be added and removed responsive to user input and selection.

FIG. 7B illustrates an example screen shot of a channel editor interface in a three-dimensional visualization software. The screen shot may include a plurality of channels, each channel represented by a driver and possibly one or more keys. The keys may define specified states within the sequence, and the software may interpolate drive values between the keys.

FIG. 7C illustrates an example screen shot of fur GUI in a three-dimensional visualization software. The screen shot may include options and selections related to fur properties. For example, fur may be enabled on the object, a texture may be loaded from a specified file, and various properties of the fur may be specified. Fur properties may include a length scale, a spread scale, color sourcing, fur thinning, anisotropic light, shells, and fins.

FIG. 7D illustrates an example screen shot of a glow shader interface in a three-dimensional visualization software. The screen shot may include options and selections related to glow properties. For example, glow may be enabled on the object, a glow mask may be selected, a constant glow option may be selected, a glow amount and size may be specified, and a glow scale may be defined.

FIG. 7E illustrates an example screen shot of hot key definition interface in a three-dimensional visualization software. The screen shot may display various functions of the software that can be associated with a hot key. For example, hot keys may allow the user to quickly activate a function by entering the hot key combination on a keyboard input.

FIG. 7F illustrates an example screen shot of a layers interface in a three-dimensional visualization software. The screen shot may include layer properties associated with each layer. For example, a layer may be created and various properties enabled. A layer may include a plurality of names, and properties may include whether it is visible in the preview window, whether it is selectable by the user, or whether it is displayed as a wire frame or in low resolution.

FIG. 7G illustrates an example screen shot of a light set object interface in a three-dimensional visualization software. The screen shot may include a tree structure of selectable light set objects for a scene. The user may select which light set objects to be displayed in the scene.

FIG. 7H illustrates an example screen shot of a phong shader interface in a three-dimensional visualization software. The screen shot may include user-inputs for various characteristics of phong shading used in the scene. Phong shading may be a set of techniques in three-dimensional computer graphics combining a model for the reflection of light from surfaces with a compatible method of estimating pixel colors using interpolation of surface normals across rasterized polygons.

FIG. 7I illustrates an example screen shot of a point light system interface in a three-dimensional visualization software. The screen shot may include an interface to receive user inputs regarding a point light system. For example, the point light system may include a name, an enablement selection, and light properties. Point light properties may include falloff, range, color, intensity, and enabling shadow source, diffuse, and specular effects. Point light properties may also be selected to affect furs and glows. A point light transform may also be inputted.

FIG. 7J illustrates an example screen shot of a projected light system interface in a three-dimensional visualization software. The screen shot may include an interface to receive user inputs regarding a projected light system. For example, the projected light system may include a name, a texture file, and an enablement selection. The light may include properties such as color, angle, aspect, range, angles, shaft, and shadow qualities.

FIG. 7K illustrates an example screen shot of a reflection shader interface in a three-dimensional visualization software. The screen shot may include an interface to receive user inputs regarding reflection properties. For example, reflection properties may include color, index of refraction, blur, planarity, etc. Various maps may be used to modify the reflection.

FIG. 7L illustrates an example screen shot of a render preferences interface in a three-dimensional visualization software. The screen shot may include an interface to receive user inputs and selections of render preferences. For example, the user may select a renderer to utilize, whether to render with shadows, whether to render the textures matte, whether to render in low resolutions. The selections may affect renderer performance and final sequence quality.

FIG. 7M illustrates an example screen shot of a specular shift shader interface in a three-dimensional visualization software. The screen shot may include an interface to receive user input regarding specular shift properties. For example, a specular shader may alter its color, highlight, environment reflectivity, and texture. In addition, the specular shader may utilize a map to control properties.

FIG. 7N illustrates an example screen shot of a sub surface scatter shader interface in a three-dimensional visualization software. The screen shot may include an interface to receive user input regarding sub surface scatter properties. For example, properties may include a map selection, specular properties, translucency properties, micro structure properties, and texture properties.

FIG. 7O illustrates an example screen shot of a surface AO system interface in a three-dimensional visualization software. The screen shot may include an interface to receive user input regarding surface AO system properties. For example, the user may set various surface flags and modify ambient occlusion properties.

FIG. 7P illustrates an example screen shot of a water shader interface in a three-dimensional visualization software. The screen shot may include an interface to receive user input regarding water shader properties. For example, the color, reflection, noise, and wave properties may be modified.

In the example screen shots discussed above, graphical user interfaces may be dynamically generated responsive to the objects to be displayed. For example, if the scene includes a projected light system object, and the object is selected by the user, a display method associated with the object may be invoked. The display method may dynamically generate the interface of FIG. 5J. When the user selects a selectable option or changes a changeable property, the object may automatically update relevant properties. Furthermore, the application may automatically render a preview sequence or scene responsive to the user input.

Although the above embodiments have been discussed with reference to specific example embodiments, it will be evident that the various modification, combinations and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

What is claimed is:

1. A system for computing a fast render, comprising:
a graphics processing unit; and
a processor in communications with the graphics processing unit, the processor configured to:
receive a user-inputted value for a three-dimensional scene from a user via a graphical user interface;
substantially concurrently with receiving the user-inputted value, provide the user-inputted value to the graphics processing unit and initiating a render at the graphics processing unit;
receive a computed render from the graphics processing unit; and
initiate a display of the computed render to the user.

2. The system of claim 1, wherein the computed render is displayed to the user in substantially real-time responsive to the user-inputted value.

3. The system of claim 1, wherein the three-dimensional scene is represented by a plurality of data objects.

4. The system of claim 3, wherein the user-inputted value is stored in a specified data object.

5. The system of claim 1, wherein the user-inputted value is directly written into an onboard memory of the graphics processing unit.

6. A method for calculating an animation sequence frame, comprising:
selecting a specified frame at a point-in-time within an animation sequence from a user request;
calculating the specified frame based on, in part, frame information retrieved from a software object, wherein the frame information relates to the point-in-time within the animation sequence;
if the frame information is stored in a time-variable of the software object, retrieving a property value from the software object associated with the point-in-time; and
if the frame information is stored in a single time variable of the software object, extrapolating the frame information at the point-in-time from at least one retrieved frame information.

7. The method of claim 6, further comprising:
displaying the calculated specified frame.

8. The method of claim 7, wherein the calculated specified frame is displayed as part of the animation sequence.

9. The method of claim 6, wherein the calculations are executed on a graphics processing unit.

10. The method of claim 9, wherein the frame information is directly written into an onboard memory of the graphics processing unit.

11. A method for providing a user interface, comprising:
retrieving a set of software objects representing a three-dimensional scene;
generating a graphical user interface, wherein the graphical user interface is generated by activating a display method associated with each software object in the three-dimensional scene;
displaying the graphical user interface;
responsive to receiving a user input changing a scene property via the graphical user interface, changing a property of an affected software object; and
automatically generating a substantially real time visualization depicting an updated scene reflecting the changed software object property.

12. The method of claim 11, further comprising:
executing the visualization on a graphics processing unit.

13. The method of claim 12, wherein the changed property of the affected software object is directly written into an onboard memory of the graphics processing unit.

14. The method of claim 11, wherein each software object within the three-dimensional scene is visualized in a pass on the graphics processing unit.

15. The method of claim 14, further comprising:
responsive to a user input indicating a desired visualization complexity, altering at least one visualization complexity setting.

16. The method of claim 11, further comprising:
responsive to receiving a user input indicating a visualization setting change, altering at least one visualization setting.

17. The method of claim 11, further comprising:
rendering the software objects into a two-dimensional image for viewing.

18. The method of claim 17, wherein the visualization and rendering occur at a server.

19. The method of claim 11, wherein each channel is associated with at least one property and each property associated with a software object affected by a change in the channel.

20. The method of claim 11, wherein the channel change includes at least one of: a camera position within the scene, a software object position, a texture placement on a software object, and a material adjustment of a software object.
